(19) United States
(12) Patent Application Publication
(10) Pub. No.: US 2025/0155696 A1
(43) Pub. Date: May 15, 2025

(54) TANDEM ADAPTIVE OPTICS AND FASCILE MULTI-COLOR ADVANCES TO STRUCTURED ILLUMINATION MICROSCOPY

(71) Applicant: The University of Chicago, Chicago, IL (US)

(72) Inventors: Daozheng Gong, Chicago, IL (US); Norbert F. Scherer, Winnetka, IL (US)

(21) Appl. No.: 18/941,542

(22) Filed: Nov. 8, 2024

Related U.S. Application Data
(60) Provisional application No. 63/597,772, filed on Nov. 10, 2023.

(51) Int. Cl. G02B 21/06; G02B 5/18; G02B 21/16; G02B 21/36; G02B 27/42; G02B 27/46

(52) U.S. Cl. CPC G02B 21/06; G02B 21/16; G02B 21/36; G02B 5/1866; G02B 27/425; G02B 27/46

(57) ABSTRACT

A structured illumination microscopy system includes a plurality of lights sources. Each light source emits an excitation beam. The excitation beams vary in wavelength. The system also includes a plurality of dichroic mirrors positioned to collimate the excitation beams emitted from the plurality of light sources into a multicolor beam. A blazed grating is positioned to receive the multicolor beam and to disperse the multicolor beam into a plurality of monochrome beams. The blazed grating directs the monochrome beams toward a digital micromirror device, which is positioned to receive the plurality of monochrome beams from the blazed grating and to direct the plurality of monochrome beams toward a sample. An image sensor is positioned between the digital micromirror device and the sample. The image sensor generates an image of the sample based at least in part on an interaction of the plurality of monochrome beams and the sample.

### CROSS-REFERENCE TO RELATED APPLICATION

The present application claims the priority benefit of U.S. Provisional Patent App. No. 63/597,772 filed on Nov. 10, 2023, the entire disclosure of which is incorporated by reference herein.

### BACKGROUND

Structured illumination microscopy (SIM) is an imaging technique that is used to enhance spatial resolution. The technique involves illuminating a sample (to be imaged) with patterned light and using software to analyze the high spatial frequency information of the sample through the measured Moiré fringes (patterns) that are outside the normal range of observation. Image processing in a SIM system generally deciphers the images at approximately 2-fold higher spatial resolution than the diffraction limit, or roughly 100 nanometers (nm). As a result, SIM has advantages over other super-resolution microscopy (SRM) methods and can be used to obtain so called “super-resolution” images of large areas of samples simultaneously, to section thicker samples, for three-dimensional (3D) imaging, for live-cell imaging, etc.

### SUMMARY

An illustrative structured illumination microscopy system includes a plurality of lights sources, where each light source in the plurality is a (laser) excitation beam. The excitation beams vary in wavelength. The system also includes a plurality of dichroic mirrors positioned to collimate the excitation beams emitted from the plurality of light sources into a multicolor beam. One novel aspect of this disclosure is that the SIM system also includes other optical components such as a blazed grating or spatial light modulator (or other devices that can control or impart phase functions onto each excitation beam). A claimed novelty is the ability to easily implement multi-color SIM using a diffraction grating positioned to receive the multiple beams of different colors (wavelengths) add angular dispersion to each beam that pre-corrects a dispersion that is inherent to another active control element—a digital micromirror device (DMD)—that is used to create and rapidly switch between the patterns required for SIM illumination and image reconstruction. Alternatively (or in addition) an active device (such as a programable spatial light modulator or diffractive optical element) can be added to the optical system that allows adding arbitrary spatial phase to the transverse profile of optical beams that can be used to correct optical aberrations that these beams will encounter in the optics of the SIM system or from index of refraction heterogeneity in (thick) samples (e.g., biological tissue). In the case of the multi-color case, the blazed grating directs the plurality of monochrome beams toward a digital micromirror device (DMD). The digital micromirror device is positioned to receive the plurality of monochrome beams from the blazed grating and to direct the plurality of monochrome beams toward a sample. An image sensor can be positioned between the digital micromirror device and the sample to image (measure) the correction of wavelength-dependent diffraction effects from the DMD that if not corrected would preclude multi-color illumination and imaging. Another image sensor is positioned in a second beam path after the sample (and microscope) that collects the light emitted by the sample (either as fluorescence or as scattered light) and directs it to an array detector that generates an image of the sample based at least in part on an interaction of the plurality of monochrome beams and the sample.

In one embodiment, the plurality of laser light sources are aligned to impinge collinearly on the blazed grating (of at least 600 lines per millimeter). The blazed grating generates a first order diffraction of each of the monochrome beams, and the first order diffractions are provided (directed) to the digital micromirror device. A pair of relay lenses positioned between the blazed grating and the digital micromirror device relay the phase information from the grating to the DMD. The digital micromirror device generates a pattern and projects the pattern onto a sample plane of the sample. The pattern can be a striped binary pattern. In another embodiment, the digital micromirror projects a plurality of patterns onto a sample plane of the sample, where each pattern in the plurality of patterns includes a different angle and phase such that identical patterns are created in the sample simultaneously. The system can further include a multi-band dichroic mirror and a bandbass filter positioned to separate excitation light from emission light. One novel aspect of this system is that the optical arrangement allows the plurality of multiple laser beams of different wavelengths to simultaneously illuminate the sample with identical (phase registered) patterns created with the same single DMD for facile multi-color structured illumination microscopy (SIM). Another novel aspect is the addition of the active optical element (e.g., spatial light modulator—SLM) to the beam path (at the same position as the diffraction grating or at an optically identical position that can be added to the optical layout shown in the figures below) to allow correction of a class of optical aberrations that have been ignored in the literature (but that must be corrected to allow maximum fidelity of the optical patterns created in the samples and therefore also the accuracy and fidelity of SIM image reconstruction).

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A depicts the coordinate system used to demonstrate the blazed grating effect of DMD in accordance with an illustrative embodiment.

FIG. 1B depicts the angular dispersion effect of DMD in accordance with an illustrative embodiment.

FIG. 1C depicts a diffracted pattern of 4 colored beams (red, green, cyan, and violet) without compensation by grating in accordance with an illustrative embodiment.

FIG. 1D depicts a table that shows various example wavelengths that fulfill equation 2 in accordance with an illustrative embodiment.

FIG. 2A depicts the angular dispersion effect of DMD with compensation by a grating in accordance with an illustrative embodiment.

FIG. 2B depicts a diffracted pattern of 4 colored beams with compensation by the grating in accordance with an illustrative embodiment.

FIG. 3A depicts a schematic of a gDMD-SIM optical setup in accordance with an illustrative embodiment.

FIG. 3B depicts diffraction patterns at the Fourier plane when different angles of binary patterns are displayed by the DMD (B1-B3) along with a merger of the diffraction patterns (B4) in accordance with an illustrative embodiment.

FIG. 4A depicts wide-field images of bead samples in 3 channels in accordance with an illustrative embodiment.

FIG. 4B depicts SIM images of bead samples in 3 channels in accordance with an illustrative embodiment.

FIG. 4C depicts FRC correlation curves of wide-field and SIM images in 3 channels in accordance with an illustrative embodiment.

FIG. 5A shows WF and SIM images of the microtubules (642 nm channel, red), actin (532 nm channel, yellow), mitochondria (488 nm channel, green), and nucleus (405 nm channel, blue) in accordance with an illustrative embodiment.

FIG. 5B depicts WF and SIM images of the region of interest (B) illustrated in FIG. 5A in accordance with an illustrative embodiment.

FIG. 5C depicts WF and SIM images of the region of interest (C) illustrated in FIG. 5A in accordance with an illustrative embodiment.

FIG. 5D depicts WF and SIM images of the region of interest (D) illustrated in FIG. 5A in accordance with an illustrative embodiment.

FIG. 5E depicts WF and SIM images of the region of interest (E) illustrated in FIG. 5A in accordance with an illustrative embodiment.

FIG. 5F shows intensity profiles of the microtubule channel in region of interest (B) in accordance with an illustrative embodiment.

FIG. 5G depicts intensity profiles of the actin channel in region of interest (C) in accordance with an illustrative embodiment.

FIG. 5H depicts intensity profiles of the mitochondria channel in region of interest (D) in accordance with an illustrative embodiment.

FIG. 5I depicts intensity profiles of the nucleus channel in region of interest (E) in accordance with an illustrative embodiment.

FIG. 6 shows a detailed ray tracing schematic of incident and diffraction rays on the interface of DMD in accordance with an illustrative embodiment.

FIG. 7 depicts calculated results of the output deviation 401 of different wavelength beams versus the incident angle do onto the blazed grating in accordance with an illustrative embodiment.

FIG. 8A is a schematic of the working principle of pupil AO in accordance with an illustrative embodiment.

FIG. 8B is a diagram illustrating that, for 3-beam-interference structured illumination, any phase modulation at the pupil plane can be decomposed into a combination of piston, tilt, and defocus in accordance with an illustrative embodiment.

FIG. 9A is a schematic of the working principles of conjugate AO in accordance with an illustrative embodiment.

FIG. 9B depicts a simulated aberration phase mask ϕ_{ab}(ρ,θ) (left) and the phase correction ϕ_{c}(ρ,θ) (right) in accordance with an illustrative embodiment.

FIG. 9C depicts the simulation results of the FT of the sinusoidal pattern before correction (left) and after correction (right) in accordance with an illustrative embodiment.

FIG. 9D depicts simulation results of the sinusoidal pattern (intensity) before correction (left) and after correction (right) in accordance with an illustrative embodiment.

FIG. 9E shows the line-cut profile of the cross-section (dashed line) of the pattern in FIG. 9D before and after conjugate AO correction, compared with the profile of an ideal pattern (dashed) without aberration in accordance with an illustrative embodiment.

FIG. 9F is a convergence curve of the image quality metric's value in conjugate AO simulation results in accordance with an illustrative embodiment.

FIG. 10A depicts a TACO-SIM optical setup in accordance with an illustrative embodiment.

FIG. 10B is a 3-dimensional rendering of a TACO-SIM optical system in accordance with an illustrative embodiment.

FIG. 10C depicts representative (portions of) patterns for the DMD to generate SIM illumination in accordance with an illustrative embodiment.

FIG. 10D depicts an optical aberration slide in the illumination beam path at the location shown in the schematic of FIG. 10A in accordance with an illustrative embodiment.

FIG. 11A shows an AO iteration process performed by the DM on images of fluorescent beads in accordance with an illustrative embodiment.

FIG. 11B shows a typical AO process of the SLM on the fluorescent beads images in accordance with an illustrative embodiment.

FIG. 11C shows a set of typical SIM raw images and the associated reconstruction result in accordance with an illustrative embodiment.

FIG. 11D is a wide field image of the 20 nm bead samples in accordance with an illustrative embodiment.

FIG. 11E is a SIM reconstruction image of the 20 nm bead samples in accordance with an illustrative embodiment.

FIG. 11F depicts FRC curves of the WF image and the SIM image in accordance with an illustrative embodiment.

FIG. 12A depicts samples (A1 & A2) in which no aberration was introduced in accordance with an illustrative embodiment.

FIG. 12B depicts samples (B1 & B2) in which aberration was introduced both globally and locally in accordance with an illustrative embodiment.

FIG. 12C depicts samples (C1 & C2) in which only pupil AO correction by the DM was performed in accordance with an illustrative embodiment.

FIG. 12D depicts samples (D1&D2) in which both conjugate AO by the SLM and pupil AO by the DM were performed, which is the full implementation of TACO in accordance with an illustrative embodiment.

FIG. 12E depicts an intensity profile of a cross-section (line in A1) of the illumination pattern for different conditions in accordance with an illustrative embodiment.

FIG. 12F depicts an intensity profile of a cross-section (line in A2) around the first-order spot of FTs for different conditions in accordance with an illustrative embodiment.

FIG. 12G depicts a large field of view image of the 200 nm diameter bead layer sample with structured illumination from the DMD in accordance with an illustrative embodiment.

FIG. 13A (A1-A4) are images that result from an SLM-based aberration correction process based on pattern 1 in accordance with an illustrative embodiment.

FIG. 13B (B1-B4) are images that result from an SLM-based aberration correction process based on pattern 2 in accordance with an illustrative embodiment.

FIG. 13C (C1-C4) are images that result from an SLM-based aberration correction process based on pattern 3 in accordance with an illustrative embodiment.

FIG. 13D (D1-D2) depict raw Fourier projection (FPJ) of the FTs of the entire 3 [symbol] 6 image set before and after TACO correction in accordance with an illustrative embodiment.

FIG. 14A depicts a first stage of the iterative SLM-based aberration correction process based on pattern 1 (A1, A2) in accordance with an illustrative embodiment.

FIG. 14B depicts a second stage of the iterative SLM-based aberration correction process based on pattern 3 (B1, B2) in accordance with an illustrative embodiment.

FIG. 14C depicts a third stage of the iterative SLM-based aberration correction process based on pattern 2 (C1, C2) in accordance with an illustrative embodiment.

FIG. 14D depicts a fourth stage of the iterative SLM-based aberration correction process based on pattern 1 in accordance with an illustrative embodiment.

FIG. 14E depicts image metric values associated with the iterative SLM-based aberration correction process in accordance with an illustrative embodiment.

FIG. 15A is a wide-field image of the fluorescent bead sample in accordance with an illustrative embodiment.

FIG. 15B shows SIM reconstruction after no AO correction was performed in accordance with an illustrative embodiment.

FIG. 15C depicts SIM reconstruction after only SLM correction was employed in accordance with an illustrative embodiment.

FIG. 15D depicts SIM reconstruction after only DM correction was employed in accordance with an illustrative embodiment.

FIG. 15E depicts SIM reconstruction after both SLM and DM correction (i.e., TACO) were employed in accordance with an illustrative embodiment.

FIG. 15F shows SIM reconstruction after no aberration was introduced in accordance with an illustrative embodiment.

FIG. 15G shows normalized intensity profiles along the diagonal cut through bead 2 as shown by the line in the inset in accordance with an illustrative embodiment.

FIG. 15H depicts normalized intensity profiles along the diagonal cut through the 3 beads shown by the line in the inset in accordance with an illustrative embodiment.

FIG. 15I depicts a power spectrum of images for different conditions in accordance with an illustrative embodiment.

FIG. 16A depicts a normalized intensity profile of bead 1 along a line as shown in the inset in accordance with an illustrative embodiment.

FIG. 16B depicts a normalized intensity profile of bead 2 along a line as shown in the inset in accordance with an illustrative embodiment.

FIG. 16C depicts an unnormalized intensity profile of the 3 adjacent beads along a line as shown in the inset in accordance with an illustrative embodiment.

FIG. 16D depicts a power spectrum of the same analysis as shown in FIG. 15I with linear scale y-axis instead of log scale in accordance with an illustrative embodiment.

FIG. 17A depicts a Fourier transform of the WF sample in accordance with an illustrative embodiment.

FIG. 17B depicts a Fourier transform of the no AO sample in accordance with an illustrative embodiment.

FIG. 17C depicts a Fourier transform of the SLM only sample in accordance with an illustrative embodiment.

FIG. 17D depicts a Fourier transform of the DM only sample in accordance with an illustrative embodiment.

FIG. 17E depicts a Fourier transform of the SLM and DM (TACO) sample in accordance with an illustrative embodiment.

FIG. 17F depicts a Fourier transform of the no aberration sample in accordance with an illustrative embodiment.

FIG. 18A is a first wide field image in accordance with an illustrative embodiment.

FIG. 18B depicts SIM reconstruction without TACO in accordance with an illustrative embodiment.

FIG. 18C depicts SIM construction with TACO in accordance with an illustrative embodiment.

FIG. 18D is a second wide field image in accordance with an illustrative embodiment.

FIG. 18E depicts SIM reconstruction without TACO in accordance with another illustrative embodiment.

FIG. 18F depicts SIM construction with TACO in accordance with another illustrative embodiment. No additional brightness/contrast adjustment has been added to the images.

FIG. 18G depicts normalized intensity profile along the lines as shown in the insets in accordance with an illustrative embodiment.

FIG. 18H depicts normalized intensity profile along the lines as shown in the insets in accordance with another illustrative embodiment.

FIG. 19A depicts an image of a fibroblast cell prior to use of TACO in accordance with an illustrative embodiment.

FIG. 19B depicts an image of the fibroblast cell subsequent to use of TACO in accordance with an illustrative embodiment.

FIG. 19C depicts an image of a human melanoma cell prior to use of TACO in accordance with an illustrative embodiment.

FIG. 19D depicts an image of the human melanoma cell subsequent to use of TACO in accordance with an illustrative embodiment.

FIG. 20 is a block diagram of a computing system to implement an imaging system in accordance with an illustrative embodiment.

### DETAILED DESCRIPTION

Structured illumination microscopy (SIM) achieves super-resolution imaging using a phase-shifted series of sinusoidal illumination patterns to down-modulate high spatial-frequency information of samples. Digital micromirror devices (DMD) have been increasingly used to generate SIM illumination patterns due to their low price and high speed. However, the blazed grating structure of a DMD micromirror array causes strong angular dispersion for different wavelengths of light, thus severely hampering its application in multicolor imaging. Described herein is a novel multi-color DMD-SIM setup that employs a diffraction grating to compensate the dispersion, and that can be used to conduct super-resolution SIM imaging of both fluorescent beads and live cells samples with up to four color channels. This effective approach can also be directly scaled to more color channels, thereby greatly expanding the application of SIM in the study of complex multi-component structures and dynamics in soft matter, biological samples and systems, etc.

In the last 20 years there has been an explosive emergence of super-resolution microscopy. Among the various techniques in use, Structured Illumination Microscopy (SIM) provides near-ideal balance between spatial and temporal resolution, low photodamage, optical sectioning capability, and no limitation on choice of dye. These advantages make SIM an ideal choice for super-resolution microscopy studies of live biological systems. However, the adoption of SIM has been limited in great measure due to complications in its illumination setup.

A SIM system typically utilizes sinusoidal patterned illumination to shift unresolvable high spatial-frequency information into lower frequencies that can be captured within the microscope optical transfer function (OTF). Initially, diffraction gratings were used to generate the interference patterns for illumination. Then liquid crystal on silicon (LCoS) become widely adopted to generate structured illumination patterns due its higher speed and easier implementation. In recent years, digital micromirror devices (DMD) were increasingly applied in SIM pattern generation. A DMD includes an array of micro-mirrors that can be tilted into an on state or an off state individually along their diagonals, thus forming a binary pattern. Compared with a LCOS, a DMD has the advantage of lower cost while providing an orders of magnitude higher refresh rate, thus becoming an attractive solution for high-speed SIM imaging. However, the application of DMD in SIM is largely restricted because the tilted mirror array structure leads to a blazed grating diffraction effect that causes strong angular dispersion for different excitation wavelengths. To obtain an output with the desired angle and diffraction efficiency, one needs to precisely align the input angle to match the wavelength. This blazed grating effect strongly prohibits the implementation of multiple excitation wavelengths in traditional DMD-SIM.

Recently, approaches of DMD-SIM with 2 or 3 coherent excitations have been demonstrated. However, they either require that the wavelengths have an integer ratio (e.g. 488 nm: 39 647 nm≈3:4) or they involve the complication of setting up individual light paths for different excitation wavelengths, which is hard to scale to more color channels. Alternatively, incoherent light sources that are free from the diffraction effect have been used to obviate this problem. Unfortunately, this leads to decreased contrast of SIM patterns and hence inferior resolution. A solution without these complications and compromises is highly desired.

Described herein is a novel multi-color DMD-SIM imaging design that overcomes the aforementioned limitations by introducing dispersion opposite to the DMD illumination system. A blazed grating is added to counteract the dispersion effect of the DMD. It has been shown that this system can work with a wide range of laser illumination wavelengths used for biological imaging without any specific requirements. The capability of this grating-DMD-SIM (gDMD-SIM) system was demonstrated by conducting three and four-color SIM super-resolution imaging in fluorescent bead and live cell samples, respectively. Benefiting from the one-stop nature of the dispersion compensation, the proposed system can be easily scaled to even more channels of wavelengths with minimal effort.

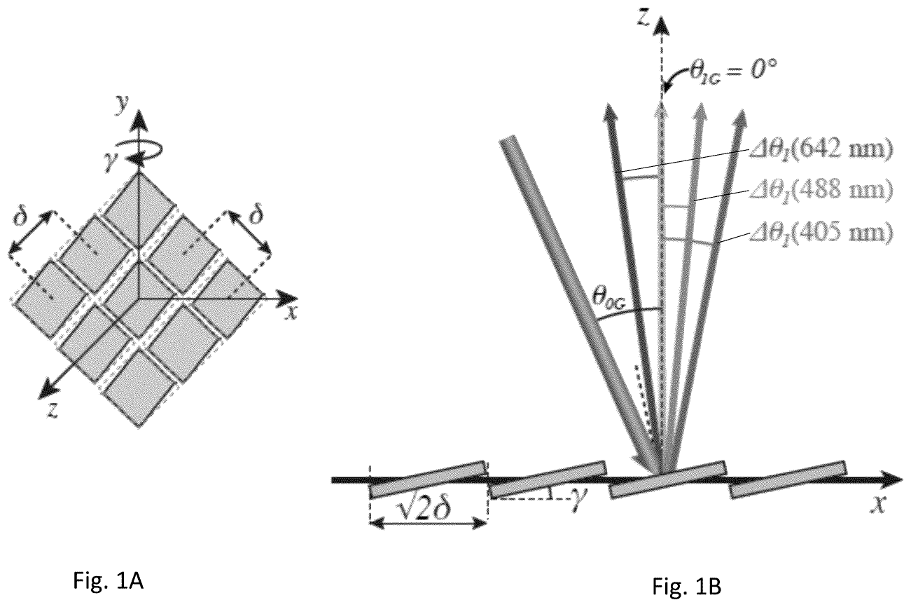

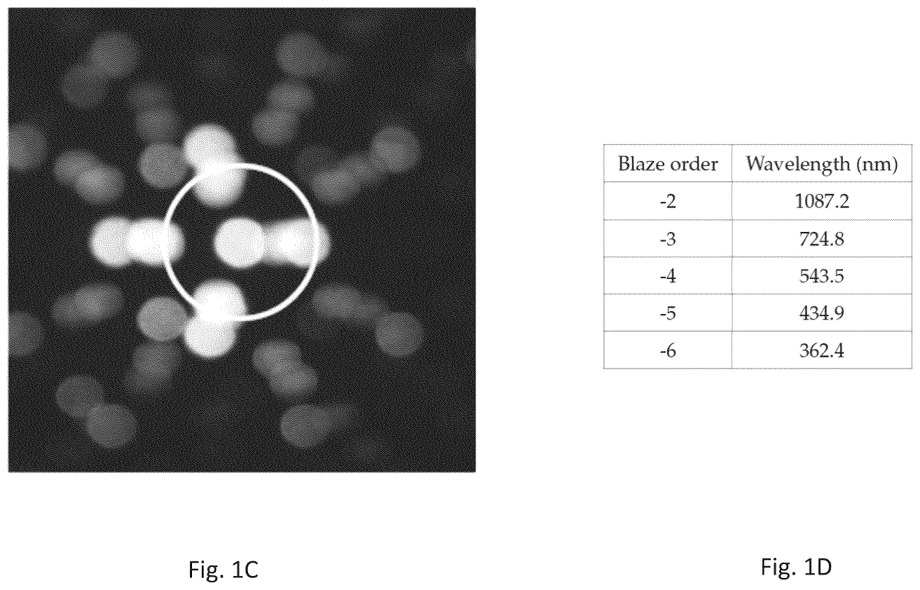

Included below is a description of dispersion compensation for a DMD. The lattice structure of the micro-mirror array makes DMD a 2-dimensional blazed grating with a blaze angle γ and line spacing d in both directions. In one testing setup, the DMD was rotated 45° in order to make the rotating axis of the micro-mirror perpendicular to the optical table. The diffraction beams that lie in the common horizontal plane with the input beam follows the grating equation:

$$\frac{\sqrt{2}}{2} δ ( sin {θ}_{1} - sin {θ}_{0} ) = m {λ}_{ex} , m ∈ N , \qquad Eq . l$$

where the θ₀ and θ₁ are incident and diffracted angle respectively and m is the order of diffraction. FIG. 1A depicts the coordinate system used to demonstrate the blazed grating effect of DMD in accordance with an illustrative embodiment. FIG. 1B depicts the angular dispersion effect of DMD in accordance with an illustrative embodiment. FIG. 1C depicts a diffracted pattern of 4 colored beams (red, green, cyan, and violet) without compensation by grating in accordance with an illustrative embodiment. In FIG. 1C, the white circle indicates the back aperture of the microscope.

At the blaze condition, one of the diffraction orders should overlap with the direct reflection of a single micro-mirror, i.e., θ₀−2γ=θ₁, leading to maximum optical power concentrated to the single diffraction order. In practice, a blaze condition at θ₁=0° will be ideal to make the blaze diffraction parallel to the optical axis. Bringing these two constraints into the equation 1, the wavelengths of excitation light that meet the blazing condition should satisfy:

$${λ}_{e x} = \frac{\sqrt{2 δ sin 2 γ}}{2 m} , m ∈ N \qquad Eq . 2$$

FIG. 1D depicts a table that shows various example wavelengths that fulfill equation 2 in accordance with an illustrative embodiment. More specifically, FIG. 1D shows blaze order and the corresponding wavelength in case of the normal diffraction. In the experiments conducted, the green laser with 532 nanometer (nm) wavelength is close to the blazing condition at m=−4 with θ₀=θ_{0G}=23.46° and θ₁=θ_{1G}=0°. However, as seen in equation 1, the diffracted angle is highly dependent on the wavelength. At the same incident angle, the other lasers can be deviated from the optical axis by an angle of Δθ₁ (λₑₓ), as shown in FIG. 1C. To address this problem, an additional blazed grating can be used to counteract the diffraction effect of DMD.

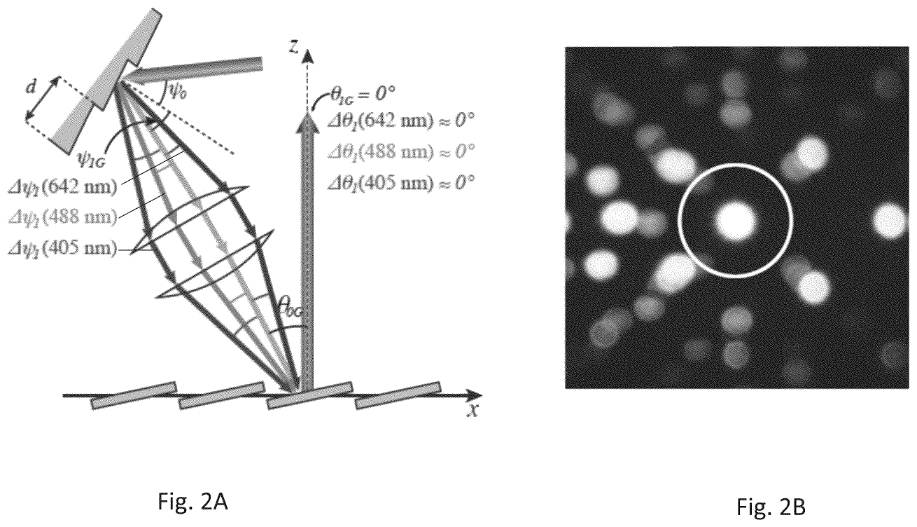

With an incident angle of ψ₀, the first order diffraction of the grating follows the following equation:

$$d ( sin ( {ψ}_{1 G} + Δ {ψ}_{1} ) - sin {ψ}_{0} ) = {λ}_{e x} , \qquad Eq . 3$$

where d is the line space of the grating, ψ_{1G} is the diffracted angle of the 532 nm green beam, and Δψ=Δψ(λₑₓ) represents the deviations of other wavelength beams related to the green beam, as shown in FIG. 2A. These deviations propagate through the relay lens pair and lead to the same deviations of the incident angles onto the DMD. The resulting grating equation of the DMD can be expressed as:

$$\frac{\sqrt{2}}{2} δ ( sin {θ}_{1 G} + Δ {θ}_{1} ) - sin ( {θ}_{0 G} + Δ {ψ}_{1} ) ) = m {λ}_{e x} \qquad Eq . 4$$

FIG. 2 illustrates a demonstration of grating dispersion compensation of the DMD blazed grating effect. Specifically, FIG. 2A depicts the angular dispersion effect of DMD with compensation by a grating in accordance with an illustrative embodiment. FIG. 2B depicts a diffracted pattern of 4 colored beams with compensation by the grating in accordance with an illustrative embodiment. In FIG. 2B, the white circle indicates the back aperture of the microscope.

Combining equation 3 and 4, one can determine the values of Δθ₁(λₑₓ) as a function of the ψ₀. When ψ₀=21.41°, it can be calculated that the Δθ₁ of 405 nm, 488 nm and 642 nm beams are 0.087°, 0.001°, 0.160° respectively, which are negligible for alignment. As shown in FIG. 2B, the −4th order diffraction of all the 4 lasers are well overlapped in the center and collimated along the optical axis.

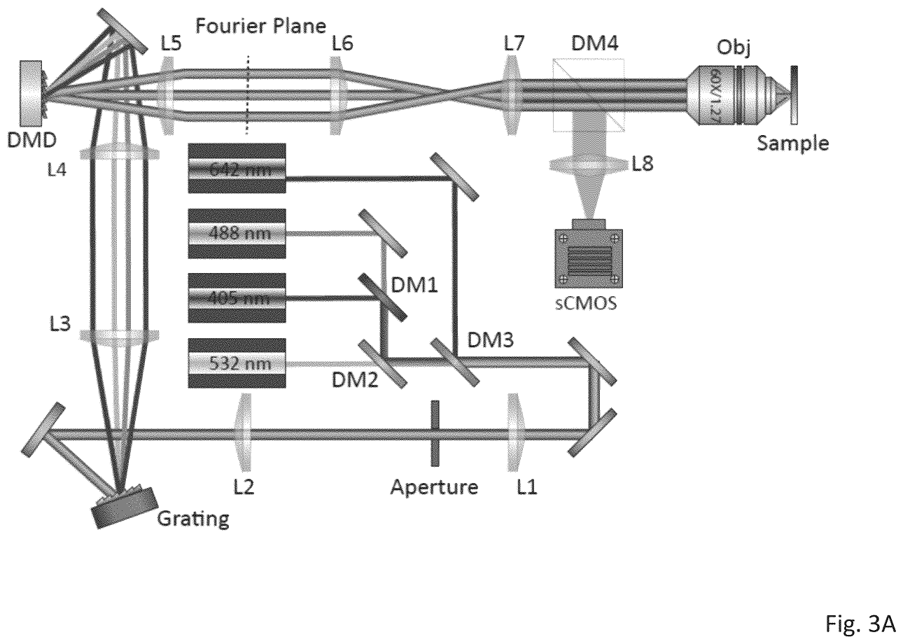

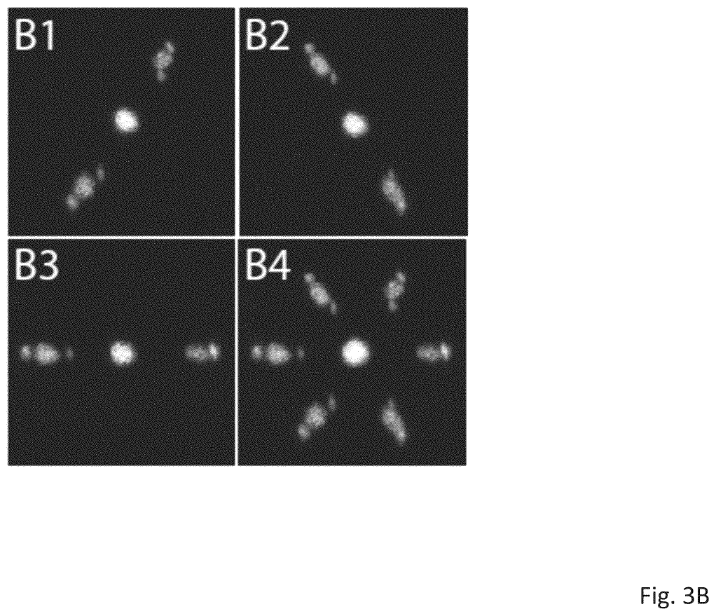

FIG. 3A depicts a schematic of a gDMD-SIM optical setup in accordance with an illustrative embodiment. As shown, four lasers with wavelengths 405, 488, 642 nm (Spectra-Physics, Excelsior One, 100 mW maximum power) and 532 (Spectra-Physics, millennia V) were used as excitation light sources. In alternative embodiments, lasers with different wavelengths may be used, a different maximum power may be used, and/or different types of excitation light sources may be used. The lasers are collimated by corresponding dichroic mirrors (DM1, DM2), expanded by a pair of lenses (L1, L2), and have their profile cleaned through a diamond pinhole in an aperture positioned between the pair of lenses. The multicolor beam is then dispersed into monochrome beams by a blazed grating with 600 lines/mm (Thorlabs, GR13-0605). Alternatively, a blazed grating with additional (e.g., 700, 800, 1000, etc.) or fewer (e.g., 500) lines/mm) lines may be used. The first-order diffraction of each wavelength beam goes through a pair of relay lenses (L3, L4) with unitary magnification and then converges at the plane of the DMD (Texas instrument, DLP9000X VIS WQXGA). The DMD contains an array of 1600×2560 micromirrors with pixel pitch δ=7.56 μm, and tilted angle γ=12°. The patterns generated by the DMD are projected to the sample plane and magnified through a pair of relay lenses (L5, L6), tube lens L7, and the objective lens (SR Plan Apo, 60×, 1.27WI, Nikon). In alternative embodiments, different system components (e.g., lenses, DMD, etc.) may be used, and the components may be arranged in a different configuration.

When doing SIM imaging, striped binary patterns with different angles and phases are displayed by the DMD in a time series. These binary patterns lead to 2 more diffraction orders around the collimated beams (m=−4 diffraction order). FIG. 3B depicts diffraction patterns at the Fourier plane when different angles of binary patterns are displayed by the DMD (B1-B3) along with a merger of the diffraction patterns (B4) in accordance with an illustrative embodiment. The radial shifts of the ±1 orders between different wavelengths, caused by the grating of the binary patterns, are harmless since they are symmetric about the optical axis. These three diffraction orders are collected by the microscope aperture and serve as the center order and ±1 orders to form the interference patterns at the sample plane. The same set of SIM patterns with the second-order spatial frequency of 2.86 μm⁻¹ (i.e. 350 nm) at the sample plane was used for all color channels, leading to a theoretical resolution improvement of 1.93×(642 nm channel), 1.80×(532 nm channel), 1.71×(488 nm channel), and 1.60×(405 133 nm channel).

A multi-band dichroic mirror (Semrock, Di01-135 R405/488/532/635) and a bandpass filter (Semrock, FF01-136 446/510/581/703-25) were used to separate the excitation and emission light. A scientific complementary metal-oxide semiconductor (sCMOS) camera (Teledyne, Kinetix) was used to record the fluorescent image. FairSIM, an imageJ-based open source software was used to perform super-resolution SIM reconstruction. In alternative embodiments, a different type of dichroic mirror, bandpass filter, camera, and/or software may be used.

To test the capability of the microscope, the inventors first conducted 3-color SIM imaging of multi-color fluorescent beads samples with a diameter of 100 nm by both wide-field and SIM imaging. The process of sample preparation for both beads and cell samples is described below.

For the beads, TetraSpeck 0.1 μm microspheres (ThermoFisher, T7279) were used to make bead samples. Before using, the bead stock solution was first uniformly suspended by sonicating for 10 minutes. Four to six microliters (μL) of the bead suspension was applied on a pre-cleaned coverslip and air-dried overnight. Ten μL of mounting medium was then applied to the fully dried coverslip. The coverslip was then placed on a precleaned microscope slide and sealed with nail polish.

For the cells, human BJ fibroblast cells were cultured in high-glucose DMEM (Life Technologies 10569) containing fetal bovine serum (10%, Life Technologies 26140) and penicillin-streptomycin in a 5% CO₂ humidified incubator at 37° C. Before imaging, live cells were washed with PBS (Life Technologies 15140) and then trypsinized in 2.5 mL trypsin (0.05%, Life Technologies 25300) at 70-80% confluence before being moved to 35 mm glass bottom dishes (Mattek P35G-1.5-14-C) for microscopy imaging. The staining solution was made by diluting Tubulin Tracker Deep Red (ThermoFisher Scientific, T34077) to 1 [symbol] , CellMask Orange Actin Tracking Stain (ThermoFisher Scientific, A57247) to 2 [symbol] , MitoTracker Green FM (ThermoFisher Scientific, M7514) to 100 nM, and Hoechst 34580 (ThermoFisher Scientific, H21486) to 5 μg/mL in growth media. For imaging, cells were incubated in 1 mL staining solution for 30 minutes at 37° C., rinsed 5 times in FluoroBrite DMEM (ThermoFisher, A1896701), then imaged and analyzed in the FluoroBrite DMEM.

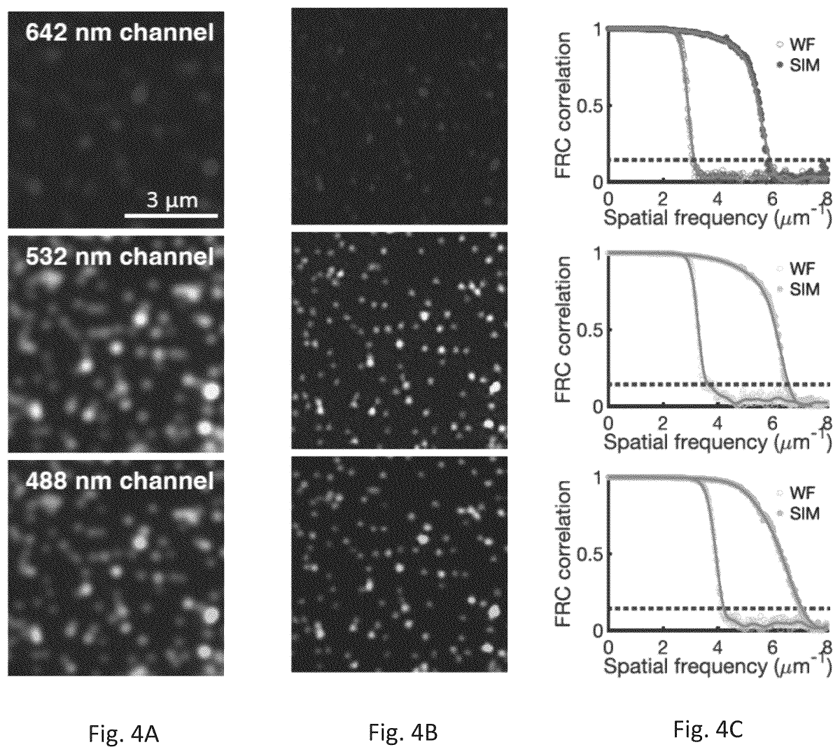

FIG. 4 shows 3-color SIM imaging of fluorescent bead samples. FIG. 4A depicts wide-field images of bead samples in 3 channels in accordance with an illustrative embodiment. FIG. 4B depicts SIM images of bead samples in 3 channels in accordance with an illustrative embodiment. FIG. 4C depicts FRC correlation curves of wide-field and SIM images in 3 channels in accordance with an illustrative embodiment. Compared with wide-field images (FIG. 4A), it can be seen that the SIM reconstructed images (FIG. 4B) show significant spatial resolution improvements in all three color channels. Fourier ring correlation (FRC) analysis was conducted to quantitatively determine the resolution improvements. The image resolutions were determined as when the FRC curves drop below a fixed threshold of 1/7. SIM imaging and FRC analysis were conducted in 8 different fields of view. The resolutions of wide field/SIM images are determined as 325.6±4.9/168.5±1.2 nm (642 nm channel), 279.3±3.0/152.9±1.8 nm (532 nm channel) and 242.3±3.7/141.8±1.6 nm (488 nm channel), corresponding to resolution improvements of 1.93±0.03×, 1.83±0.03× and 1.71±0.03×, respectively (FIG. 4C). These results match the theoretical calculation of the expected resolution improvement very well.

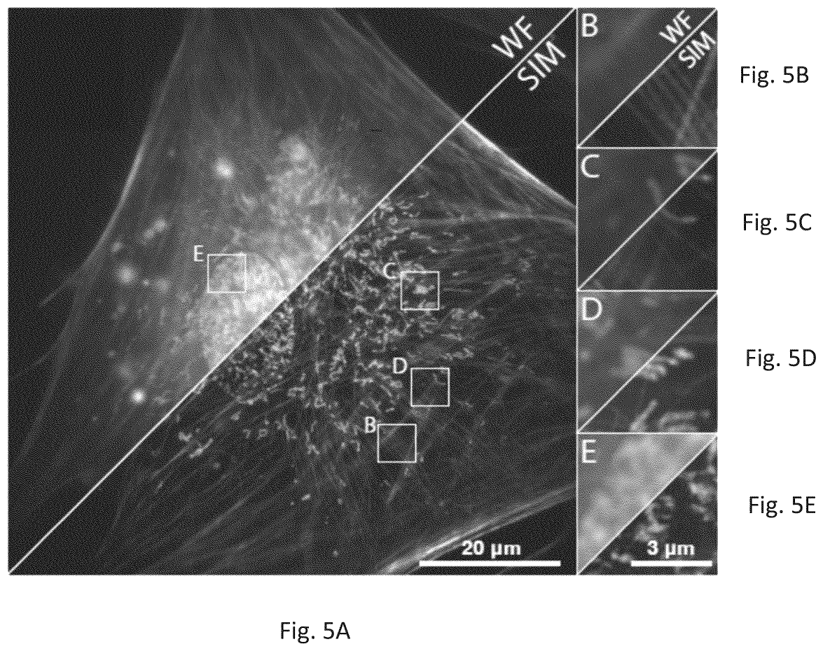

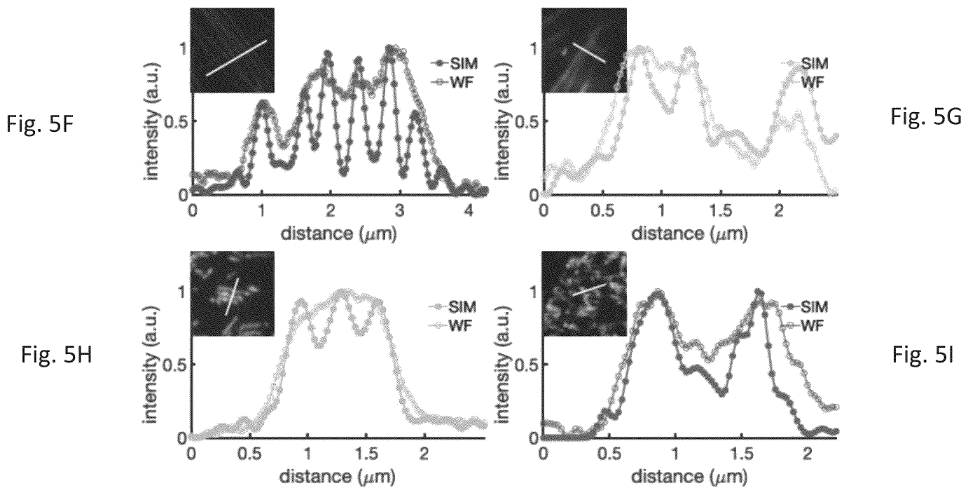

The inventors further performed 4-color SIM imaging of live human BJ fibroblast cells. The wavelengths of 642 nm, 532 nm, 488 nm, and 405 nm excitation were used to image tubulin, actin, mitochondria, and nucleus labeled with Tubulin Tracker deep read, CellMask Orange, MitoTracker, and Hoechst respectively. FIG. 5 depicts 4-color SIM imaging of live human BJ fibroblast cells. FIGS. 5A-5E show the resulting fluorescent images with composite color channels. Additionally, some representative measurements of intensity profiles of individual structures in WF and SIM images are shown in FIGS. 5F-5I.

FIG. 5A shows WF and SIM images of the microtubules (642 nm channel, red), actin (532 nm channel, yellow), mitochondria (488 nm channel, green), and nucleus (405 nm channel, blue) in accordance with an illustrative embodiment. FIG. 5B depicts WF and SIM images of the region of interest (B) illustrated in FIG. 5A in accordance with an illustrative embodiment. FIG. 5C depicts WF and SIM images of the region of interest (C) illustrated in FIG. 5A in accordance with an illustrative embodiment. FIG. 5D depicts WF and SIM images of the region of interest (D) illustrated in FIG. 5A in accordance with an illustrative embodiment. FIG. 5E depicts WF and SIM images of the region of interest (E) illustrated in FIG. 5A in accordance with an illustrative embodiment. FIGS. 5F-5I show a comparison of normalized intensity profiles of WF and SIM images along the white line shown in the insets. Specifically, FIG. 5F shows intensity profiles of the microtubule channel in region of interest (B) in accordance with an illustrative embodiment. FIG. 5G depicts intensity profiles of the actin channel in region of interest (C) in accordance with an illustrative embodiment. FIG. 5H depicts intensity profiles of the mitochondria channel in region of interest (D) in accordance with an illustrative embodiment. FIG. 5I depicts intensity profiles of the nucleus channel in region of interest (E) in accordance with an illustrative embodiment.

The SIM image shows significantly superior quality compared with the WF image (FIG. 5A). The improvement of resolution allows the SIM image to resolve many more structural details that are indistinguishable in the WF, such as contiguous microtubules (FIGS. 5B & 5F), actin filaments (FIGS. 5C & 5G), and mitochondria (FIGS. 5D & 5H). Furthermore, as can be seen in FIGS. 5E & 5I, the optical-sectioning ability of SIM reconstruction helps filter out the out-of-focus fluorescence signal and leads to a much clearer background compared to WF images.

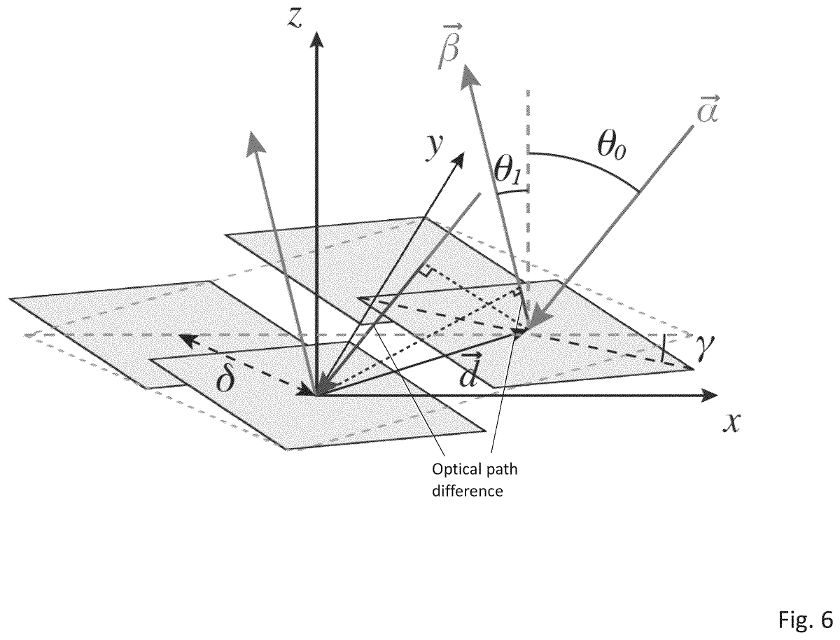

Included below is additional description of the diffraction characteristics of DMD. The lattice structure of the micro-mirror array makes DMD a diffraction grating. As FIG. 1A shows, the micro-mirror array can be considered as a 2-dimensional blazed grating, with a line spacing d=7.56 μm in both directions. In one embodiment, each micro-mirror is tiled by an angle g=12° along the diagonal. In practice, the whole DMD was rotated by 45°, so that the tilting is along y axis. FIG. 6 shows a detailed ray tracing schematic of incident and diffraction rays on the interface of DMD in accordance with an illustrative embodiment. In FIG. 6, the coordinate system is the same as that used in FIG. 1A. The identified line segments represent the optical path difference between two adjacent micro-mirrors of incident rays (\vec{d}·\vec{α}) or diffraction rays \vec{d}·\vec{β}). In this coordinate system, the lattice vector \vec{d} that joins two contiguous micro-mirrors can be expressed as:

$$\vec{d} = ( \frac{\sqrt{2}}{2} δ , \frac{\sqrt{2}}{2} δ , 0 ) . \qquad Eq . 5$$

The incident ray \vec{α} and diffraction ray \vec{β} can be defined as:

$$\vec{α} = - ( sin {θ}_{0} cos {ϕ}_{0} , sin {θ}_{0} sin {ϕ}_{0} , cos {θ}_{0} ) and \qquad Eq . 6$$

$$\vec{β} = ( sin {θ}_{1} cos {ϕ}_{1} , sin {θ}_{1} sin {ϕ}_{1} , cos {θ}_{1} ) , \qquad Eq . 7$$

where (θ₀,ϕ₀) are the angles of d between the z and x axes, and (θ₁,ϕ₁) are the angles of \vec{β} between the z and x axes. The optical path difference between two adjacent micro-mirror pixels is given by:

$$Δ = \text{} \vec{d} \cdot \vec{α} + \vec{d} \cdot \vec{β} = \frac{\sqrt{2}}{2} δ ( sin {θ}_{1} ( cos {ϕ}_{1} + sin {ϕ}_{1} ) - sin {θ}_{0} ( cos {ϕ}_{0} + sin {ϕ}_{0} ) ) . \qquad Eq . 8$$

The diffraction pattern is given by the grating equation as follows:

$$Δ = m {λ}_{ex} , m ∈ ℕ , \qquad Eq . 9$$

where m is the diffraction order number. At blaze condition, one of the diffraction orders should overlap with the direct reflection of a single micro-mirror such that:

$${θ}_{0} - 2 γ = {θ}_{1} , and \qquad Eq . 10$$

$${ϕ}_{0} = - {ϕ}_{1} . \qquad Eq . 11$$

This will lead to maximum optical power concentrated to the single diffraction order. In practice, in order to maintain the parallelism between the optical path and optical table, one can constrain the incident light to be perpendicular to the y axis, i.e., ϕ₀=0. In addition, to make blazing diffraction parallel to the optical axis, a blaze condition at θ₁=0° can be used. This leads to θ₀=2γ=24°. Bringing these two constraints into the diffraction equation, one can obtain the wavelengths of excitation light that meet the blazing condition by satisfying:

$${λ}_{e x} = - \frac{\sqrt{2} δ sin 2 γ}{2 m} , m ∈ ℕ . \qquad Eq . 12$$

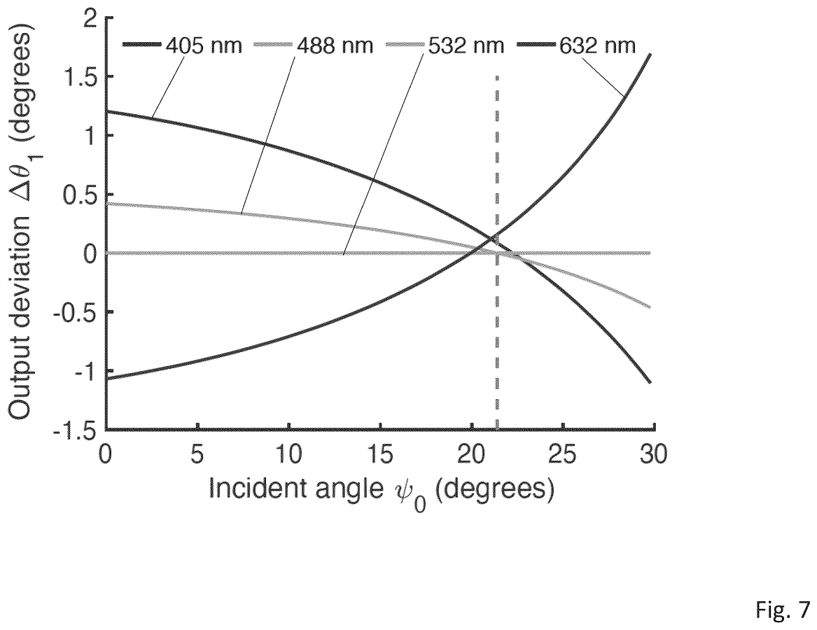

It is thus apparent that the blaze condition can only be fulfilled with certain discrete wavelengths. In the table of FIG. 1D, there is a list of some of those wavelengths that give rise to a blazing diffraction directed perpendicular the DMD interface. It is noted that conventional lasers output wavelengths that do not give rise to the blazing diffraction directed perpendicular to the DMD interface, which means the setup will deviate from the ideal blazing case. In the experimental system, the inventors set the incident angle of the 532 nm beam on DMD to be θ₀=θ_{0G}=23.46° and used the m=−4 order diffraction at θ₁=θ_{1G}=0° as the illumination beam that goes into the microscope. An additional blazed grating was used to compensate the deviation of other wavelengths beams. FIG. 7 depicts calculated results of the output deviation Δθ₁ of different wavelength beams versus the incident angle ψ₀ onto the blazed grating in accordance with an illustrative embodiment. As shown in FIG. 7, by adjusting the incident angle do to the blazed grating, the deviation of all the other wavelength beams can get very close to zero and thus collimate with the 532 nm beam.

Thus, described herein is a novel gDMD-SIM system that overcomes the blazed grating effect of DMD and enables multi-color imaging within a wide range of excitation wavelengths. To implement this system, a second blazed grating was placed relaying to the DMD's position. With an optimal incident angle (which can be determined as described above), the grating introduces an opposite dispersion to the DMD and thus cancels out output angle differences between different excitation beams. Multi-color SIM imaging of fluorescent beads and subcellular structures has been demonstrated, as discussed above. Advantageously, the proposed method does not involve any mechanical movement or fine tuning of individual excitation light paths. Once the position and orientation of the grating is settled, it can be readily extended to more excitation channels without any extra effort other than basic collimation in the beginning.

This approach can be further extended to volumetric imaging by using a spatial light modulator (SLM) functioning as a blazed grating for dispersion compensation. The SLM can accommodate additional modulation patterns, including patterns optimized for the correction of aberrations. Such capabilities can particularly facilitate imaging through thick three-dimensional (3D) samples such as biological tissues.

It is noted that the system may have relatively low excitation energy efficiency. Since the beams are deviated from the most ideal blazed conditions of the grating and the DMD, this can cause the output energy of the excitation beams to be less than optimum. Nonetheless, SIM is well known for its low requirement for illumination intensity. In the proposed system, the final illumination intensities of the 4 excitation wavelengths at the sample plane are: 12 Watts per square centimeter (W/cm²) (642 nm), 20 W/cm² (532 nm), 16 W/cm² (488 nm) and 4 W/cm² (405 nm), which are in the feasible range for SIM imaging. In the experiments, the photon budget is not limited by the power of the light source, but is instead limited by the photobleaching and phototoxicity.

Overall, the proposed gDMD-SIM system offers a promising approach to achieve multi-color DMD-SIM imaging, which is a technique that has been challenging for researchers using traditional techniques and systems. The proposed methods feature straight forward scalability to additional color channels and possess substantial potential for widespread adoption across diverse domains of biological research.

Another illustrative embodiment is directed to tandem aberration correction optics in wide-field structured illumination microscopy. As discussed herein, structured illumination microscopy (SIM) is a powerful super-resolution imaging technique that uses patterned illumination to down-modulate high spatial-frequency information of samples. However, the presence of spatially-dependent aberrations can severely disrupt the illumination pattern, limiting the quality of SIM imaging. Conventional adaptive optics (AO) techniques that employ wavefront correctors (wavefront correction) at the pupil plane are not capable of effectively correcting these spatially-dependent aberrations.

Described herein is a Tandem Aberration Correction Optics (TACO) approach that combines both pupil AO and conjugate AO for aberration correction in SIM. In one embodiment, a TACO system incorporates a deformable mirror (DM) for pupil AO in the detection path to correct for global aberrations, while a spatial light modulator (SLM) is placed at the plane conjugate to the main source of aberrations, termed conjugate AO, to compensate for spatially-varying aberrations in the illumination path. Numerical simulations and experimental results show that the TACO approach can recover the illumination pattern at close to an ideal condition, even when severely misshaped by aberrations, resulting in high-quality super-resolution SIM reconstruction. The TACO approach resolves a critical traditional shortcoming of aberration correction for the field of structured illumination, as well as other wide-field-based illumination microscopies. This advance significantly expands the application of wide-field imaging in the study of complex (e.g., biological) samples.

Advances in optical microscopy have played a key role in biological scientific research. Many biological features and phenomena have been elucidated as a result of the better spacing and techniques used in current microscopy systems. However, the quality of microscopy imaging is often hampered by optical aberration. The associated phase variations (i.e., relative to ideal forms) in the wavefront of the illumination light and the emission light arise from multiple factors such as index of refraction variations, sample scattering associated with the intrinsic inhomogeneity of complex and biological samples, and misalignment and non-ideality of optics. These aberrations lead to decreased resolution, degraded signal-to-noise ratio (SNR), and decreased fidelity in microscopy images.

In recent years, adaptive optics (AO) has emerged as a promising approach to mitigate optical aberrations in microscopy. The idea of traditional AO is to add phase modulation opposite to the aberration using wavefront correctors such as deformable mirrors (DM) or spatial light modulators (SLM).

Aberration correction with adaptive optics has been dominantly applied to point scanning microscopy, e.g., confocal microscopy or multiphoton microscopy, where a phase modulator is generally placed at the pupil plane, termed pupil AO, to correct aberrations that blur the illumination point and point spread function (PSF). By contrast, aberration correction for wide-field illumination has been largely overlooked and considered to be of negligible importance because of the simplicity of the illumination distribution at the pupil plane. While this might be a reasonable assumption for uniform wide-field illumination, it does not hold true for structured illumination microscopy (SIM), which involves careful consideration of aberration correction beyond just the pupil plane.

SIM is a wide-field based super-resolution imaging technique that utilizes patterned illumination (typically sinusoidal patterns) to down-modulate high spatial frequency information of a sample into low-frequency beat frequencies, also known as the Moiré effect. High-resolution images can then be reconstructed by extracting high-frequency information from these beat patterns. However, the reconstruction process is highly sensitive to errors in the patterns. Achieving robust reconstruction with minimal artifacts requires that a high-quality pattern be projected onto the sample.

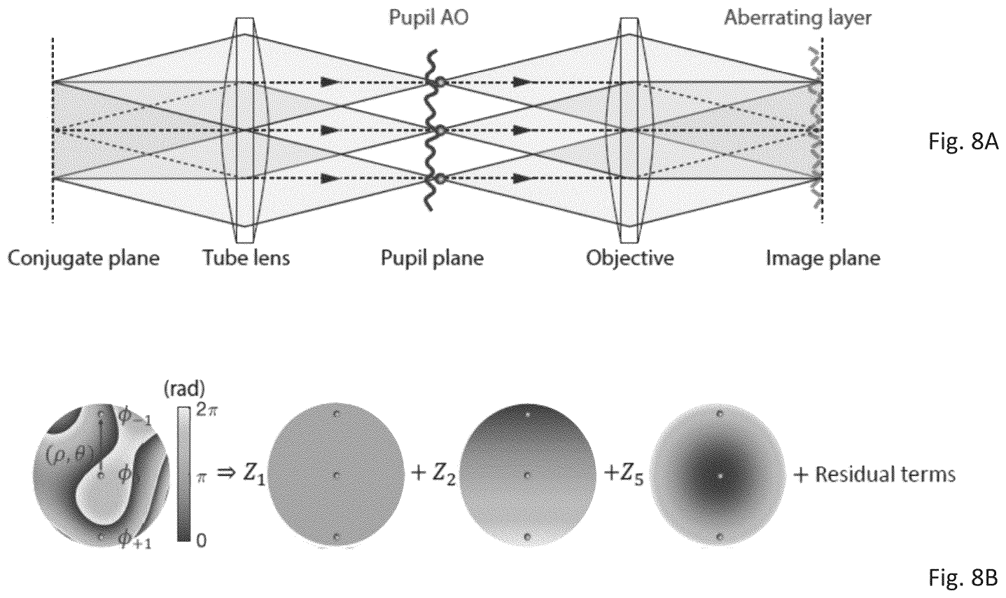

Despite the aforementioned strict requirement for high-fidelity illumination patterns, SIM has long been considered immune to aberrations. However, this assumption is only true if spatially-invariant aberrations are considered. Aberrations, such as spherical aberration, astigmatism, and comma have a global effect on the whole field of view (FOV) and can be represented by simple (e.g. parabolic) phase variation functions at the pupil plane of the optical system. To illustrate, one can consider a sinusoidal illumination pattern that is formed by the interference of 2 or 3 coherent beams. The optical transfer function (OTF) of the pattern only includes 2 or 3 wavevectors (points) in the pupil plane, as shown in FIG. 8. More specifically, FIG. 8 shows pupil AO aberration correction for structured illumination.

FIG. 8A is a schematic of the working principle of pupil AO in accordance with an illustrative embodiment. FIG. 8B is a diagram illustrating that, for 3-beam-interference structured illumination, any phase modulation at the pupil plane can be decomposed into a combination of piston, tilt, and defocus in accordance with an illustrative embodiment. The residual term has no effect on the illumination pattern. In FIGS. 8A and 8B, the three vertically separated points represent the 3 diffraction limited spots of the illumination beam(s) at the pupil plane. The phase modulation exerted to the 3 points are denoted by ϕ_{0±1}. The polar coordinate system of the pupil plane is denoted by (ρ,θ). For this reason, spatially-invariant aberrations have a very limited effect on the illumination light, and only cause phase or orientation shifts to the illumination pattern. Consequently, almost all adaptive optics applications in traditional SIM have focused on using pupil AO in the detection path. Even when an AO corrector is placed at a shared pupil plane of both the illumination and detection path, it essentially has no effect on the illumination pattern and only corrects the detection path.

However, in biological imaging, the aberrations induced by the intrinsic heterogeneity of samples can cause severe distortion to a structured illumination pattern. Unlike spatially-invariant aberration, these sample-induced aberrations are spatially varying around the image plane (i.e. sample), and pupil AO can only correct a very limited field of view (FOV). Unfortunately, this spatially-varying source of aberrations has been widely neglected, and a method to address spatially-varying aberrations in structured illumination is urgently needed.

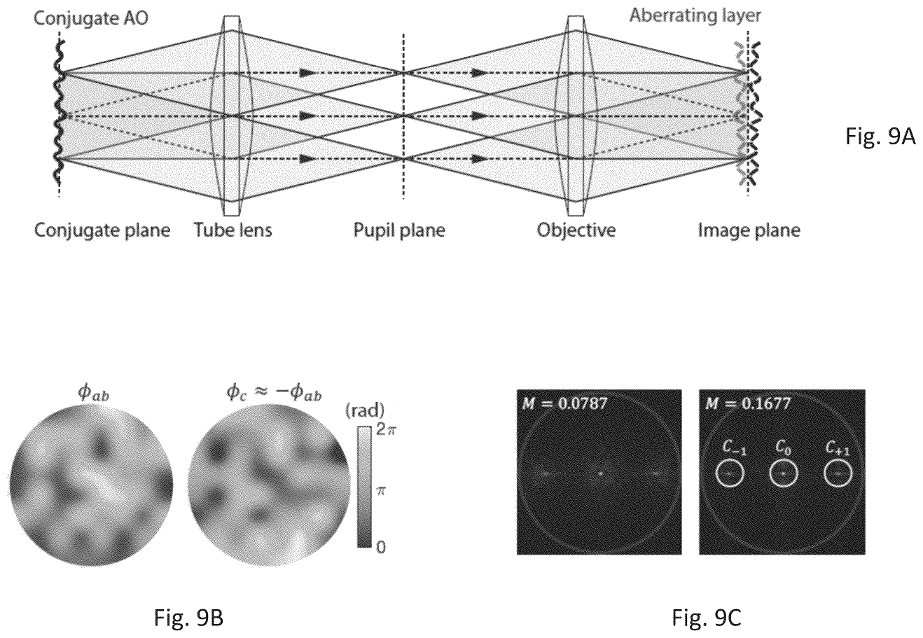

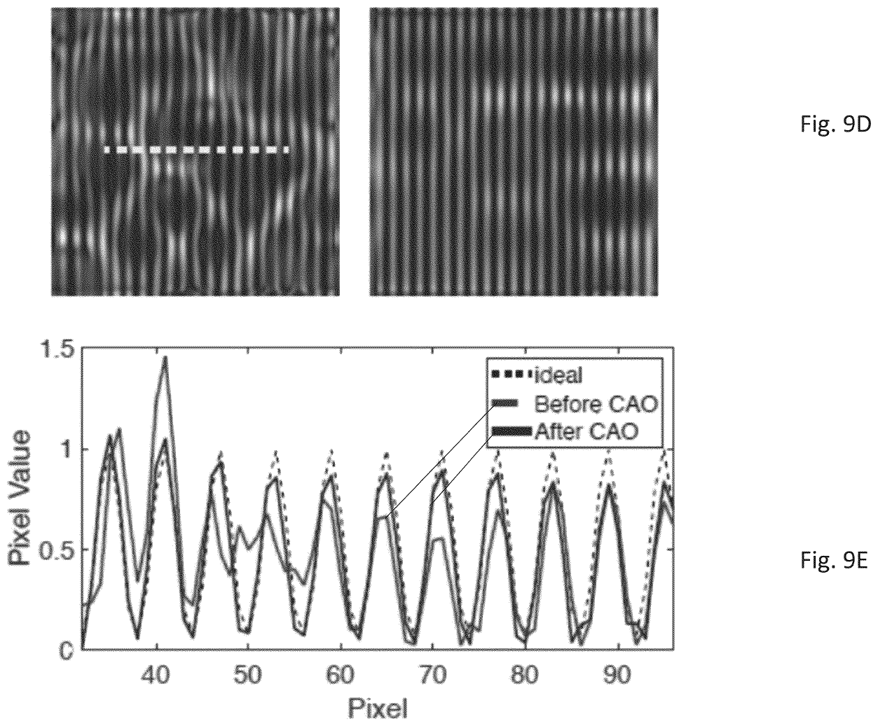

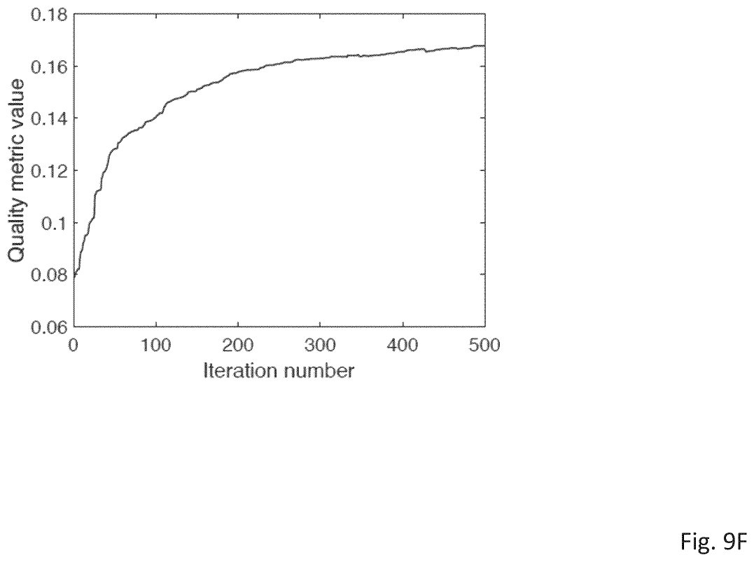

One approach to address spatially-varying aberration is through conjugate AO, which refers to placing an AO corrector at a plane conjugate to the main source of aberration. Doing so directly maps the plane of phase modulation to the aberration plane and allows correcting the entire FOV with a single (but potentially complicated) correction function (see FIG. 9). FIG. 9 depicts conjugate AO aberration correction for structured illumination.

FIG. 9A is a schematic of the working principles of conjugate AO in accordance with an illustrative embodiment. FIG. 9B depicts a simulated aberration phase mask ϕ_{ab}(ρ,θ) (left) and the phase correction ϕ_{c}(ρ,θ) (right) in accordance with an illustrative embodiment. FIG. 9C depicts the simulation results of the FT of the sinusoidal pattern before correction (left) and after correction (right) in accordance with an illustrative embodiment. The horizontally spaced circles in FIG. 9C indicate the sub-images used for calculating the image quality metric M, and the larger circle indicate the pupil plane. FIG. 9D depicts simulation results of the sinusoidal pattern (intensity) before correction (left) and after correction (right) in accordance with an illustrative embodiment. FIG. 9E shows the line-cut profile of the cross-section (dashed line) of the pattern in FIG. 9D before and after conjugate AO correction, compared with the profile of an ideal pattern (dashed) without aberration in accordance with an illustrative embodiment.

The advantage of conjugate AO has already been extensively demonstrated. However, in contrast to pupil AO, conjugate AO cannot compensate for spatially-invariant aberrations such as spherical aberration, which turn out to be the most notorious aberration in the detection path of SIM. For this reason, achieving a fully aberration-corrected SIM system involves use of a tandem aberration correction that combines the advantages of both pupil AO and conjugate AO.

The SIM microscope described herein is integrated with a novel Tandem Aberration Correction Optics (TACO) system that uses conjugate AO and pupil AO in the illumination path and detection path, respectively. In an illustrative embodiment, a DM is used for conventional pupil AO in the detection path to correct for global aberrations, while an SLM is used to implement conjugate AO to compensate for local (spatial-varying) aberration in the illumination beam at the image plane. The effectiveness of the proposed system was demonstrated on uniform fluorescent samples, fluorescent bead layers, and cell samples. The results show that even in the presence of strong aberration, the TACO system can robustly correct aberrations and greatly enhance the quality of super-resolution reconstruction.

Described below are the adaptive optics for spatially-varying aberration of structured illumination. One can consider the structured illumination formed by 3-beam interference, which is a configuration commonly used for super-resolution SIM imaging with optical sectioning. At the pupil plane, the illumination forms 3 diffraction-limited spots located at the center (0 order, ρ=0) and periphery (+1 orders, ρ=ρ₀, θ=θ₀, θ₀+π), as shown in FIG. 8. Then after the objective, the three beams merge together, interfere at the image (i.e., focal plane), and form a periodic illumination pattern. In this process, the beams can be severely affected if traveling through a highly aberrating medium before reaching the image plane (FIG. 8A).

If pupil AO is adopted, a wavefront corrector (e.g., an SLM or a DM) is placed for phase modulation at the pupil plane, and only those SLM pixels or DM segments that co-locate with the diffraction spots affect the phase modulation and the illumination pattern. However, the finite size of the SLM pixel or small local deformation of a DM results in essentially a constant phase modulation being applied to each diffraction order (ϕ_{0±1}). Therefore, any phase modulation ϕ_{ρ}(ρ,θ) applied to the pupil can be decomposed into the following form:

$${ϕ}_{ρ} = \frac{{ϕ}_{- 1} + 2 {ϕ}_{0} + {ϕ}_{+ 1}}{4} + \frac{{ϕ}_{- 1} - {ϕ}_{+ 1}}{2} \frac{ρ}{{ρ}_{0}} cos ( θ - {θ}_{0} ) + \frac{{ϕ}_{- 1} + 2 {ϕ}_{0} + {ϕ}_{+ 1}}{4} ( 2 ( {( \frac{ρ}{{ρ}_{0}} )}^{2} - 1 ) + r e s \qquad Eq . 13$$

where the first three terms are known as the piston, tilt, and defocus Zernike modes. The combination of these three modes has the same effect on the illumination pattern as the original phase modulation ϕ_{ρ}(ρ,θ) to the 3 diffraction-limited spots and the residual terms can be neglected (FIG. 8B). However, the effect of these three modes on the illumination pattern is trivial because they simply lead to a phase shift or orientation shift of the interference pattern. Consequently, pupil AO cannot exert much effective pre-compensation to the illumination pattern to counteract subsequent distortion.

On the other hand, conjugate AO can address this problem in a rather straightforward manner. One can consider a single aberrating layer with phase modulation ϕ_{ab}(ρ,θ) in which conjugate AO is implemented by a wavefront corrector placed in a plane conjugate with the aberrating layer to which one applies an opposite phase modulation of ϕ_{c}(ρ,θ)=−ϕ_{ab}, which results in a pre-compensated illumination beam. In an ideal situation, the phase disruption from each small subregion of the aberration layer will be canceled out by the exact opposite phase modulation from the corresponding area of the wavefront corrector as shown in FIGS. 9A and 9B. However, in practice, there are factors that limit the efficacy of conjugate AO. First, the aberration may not arise from a single well-defined layer, which creates ambiguity regarding the optimal location of the wavefront corrector. In the case of a thick aberration sample, multiple conjugate AOs, or a conjugate AO with a refocusing system, might need to be adopted. Second, the aberration ϕ_{ab} is usually unknown, and one needs to either directly measure it with a wavefront sensor, or optimize the AO phase mask in an iterative manner using an image quality metric (e.g., image contrast) that can be maximized or minimized. The discussion herein assumes the case of a single aberration layer from a scattering slide, but it is noted that the TACO concept can be expanded to the case of multiple or thick aberration layers. In the case of a thick aberrating sample, conjugate AO can also be used in the detection optical path. An image-based iteration method was selected to avoid adding extra complexity to the optical apparatus. The image quality metric is defined as:

$$M = \frac{\sqrt{{C}_{- 1} ( w ) \cdot {C}_{+ 1} ( w )}}{{C}_{0} ( w )} , \qquad Eq . 14$$

where C is the contrast (i.e., standard deviation) of the sub-images around diffraction spots of the FT of a raw image and F is a user-defined window to adjust the size of the sub-images (FIG. 9C). The contrast of the ±1 pattern modulation spatial frequency wavevectors C_{±1} serve as a criterion to allow quantifying the fidelity of the sinusoidal pattern, and the 0 order spatial frequency feature C₀ in the denominator serves as a normalization to exclude the erroneous solution of increasing the overall brightness of the whole image.

To test the validity of the image quality metric M, conjugate AO correction was simulated for SIM illumination. A random phase mask was introduced near the image plane of a 4-f imaging system to cause aberration, and the phase modulation was iteratively updated at the conjugate plane to counteract the aberration by maximizing the value of the metric as shown in Equation 14. The iteration method is based on a stochastic parallel gradient descent (SPGD) algorithm. During each iteration small random perturbations are applied to the phase mask, which causes a change of the metric value of δM. The phase mask is subsequently updated using δM as an estimation for the average gradient of M versus the phase mask values. The details of the algorithm are discussed below. The value of the metric of the initial pattern is 0.0787. After 500 iterations, the metric value converged to a stable value of 0.1677. FIG. 9F is a convergence curve of the image quality metric's value in conjugate AO simulation results in accordance with an illustrative embodiment. For each iteration, an incremental adjustment of the phase modulation is updated (based on Equation 23, which is discussed below) to optimize the image quality metric value M. In this case, the value of M takes ˜500 iterations to reach a plateau.

The resulting phase modulation ϕ_{c} at the conjugate plane shows a complementary distribution compared to aberration ϕ_{ab} as shown in FIG. 9B. This indicates that most of the spatially-varying aberration has been canceled out by conjugate AO. After correction, the first-order spot the of Fourier transform (FT) of the pattern shows a ˜1.5× increase of intensity versus no correction, while the zero-order spot remains the same (FIG. 9C). FIGS. 9D and 9E show the intensity of the pattern before and after AO correction. Although the pattern has initially been severely distorted by phase aberration, the conjugate AO approach that was used almost completely compensated the aberration such that the fidelity of the modulation is virtually identical to the ideal sinusoidal un-aberrated pattern.

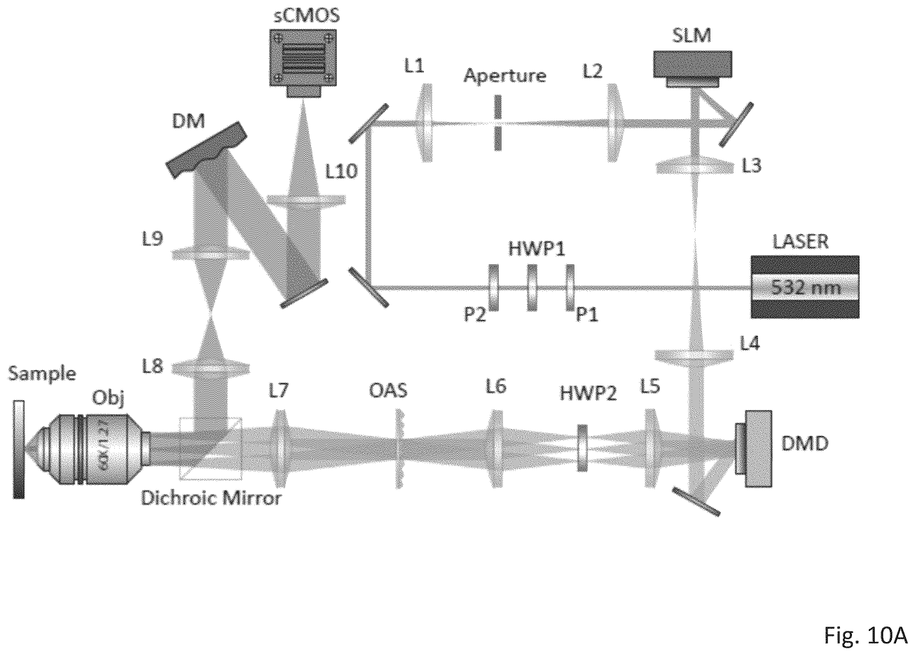

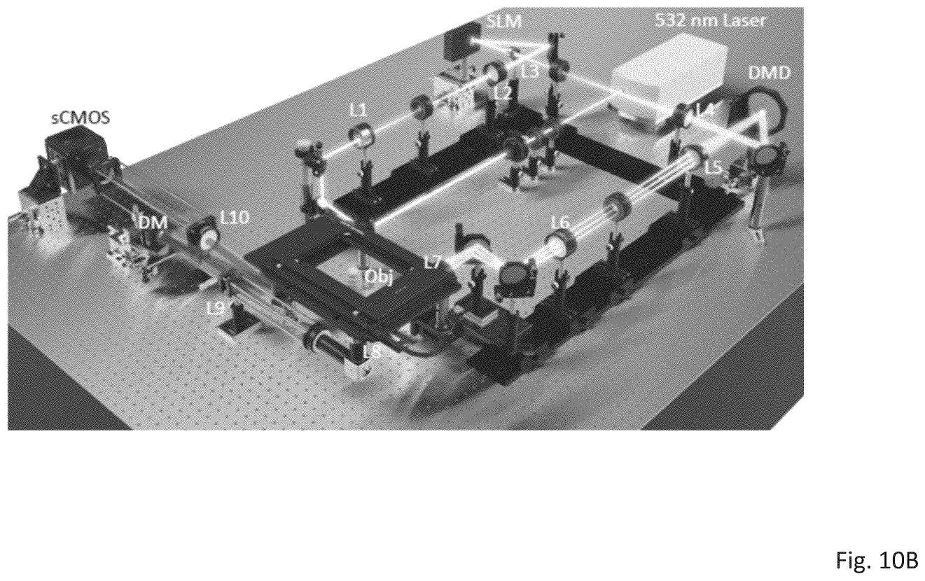

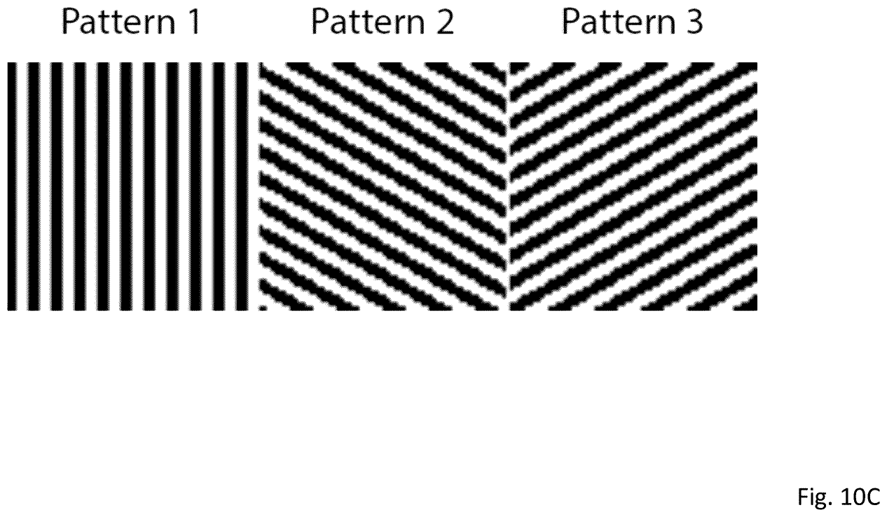

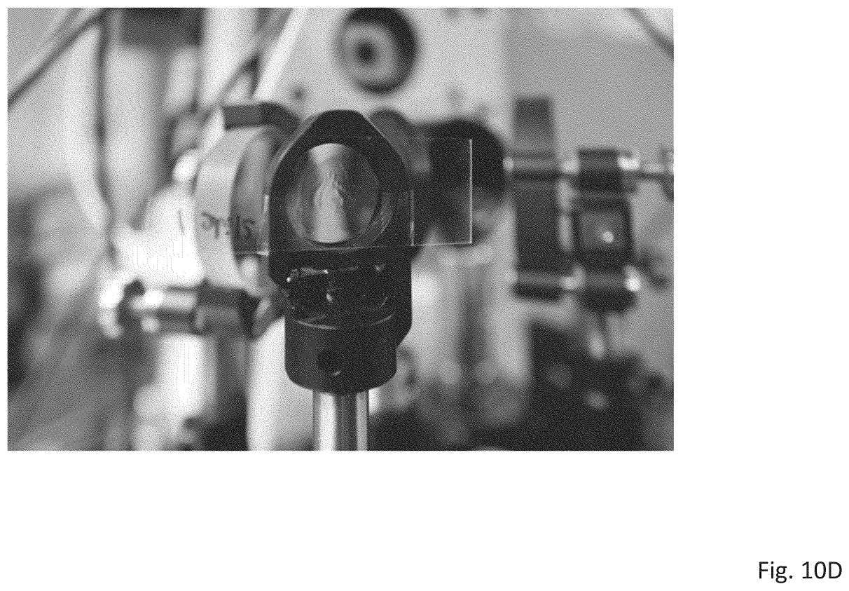

As discussed above, the microscopy setup included a structured illumination microscope (SIM) integrated with a TACO system to illustrate the comprehensive aberration correction capability. FIG. 10A depicts a TACO-SIM optical setup in accordance with an illustrative embodiment. FIG. 10B is a 3-dimensional rendering of a TACO-SIM optical system in accordance with an illustrative embodiment. In FIG. 10, HWP1-HWP2, half-wave plate; DM, P1-P2, linear polarizers; OAS, optical aberration slide; Obj, objective lens; L1-L10, lenses; lens focal lengths: f1=100 mm, f2=400 mm, f3=100 mm, f4=400 mm, f5=200 mm, f6=250 mm, 17=300 mm, f8=200 mm, 19=200 mm and f10=400 mm. A solid-state CW laser (Millennia Vs, Spectra Physics, 532 nm, 5-watt maximum power) was used as an illumination light source. The intensity and polarization of the laser beam are controlled by a pair of linear polarizers (P1, P2) and a half-wave plate (HWP1). In alternative embodiments, a different configuration and/or different system components may be used.

The laser light then passes through a 4×beam expander formed by a pair of achromatic lenses (L1, L2). A diamond pinhole was placed at the focus to clean the beam profile. A spatial light modulator (Hamamatsu LCOS-SLM X10468) was used for wavefront correction in the illumination path. An SLM was used instead of a DM to allow for more detailed phase information to be encoded in the SLM (800×600 8 bits pixels) compared to a deformable mirror (<100 piezo actuators), which allows for much more exquisite wavefront modulation to compensate for spatially-varying aberrations. The coherent beam reflected from the SLM is relayed to a digital micromirror device (Texas instrument, DLP9000X VIS WQXGA) by a pair of lenses with 4× magnification (L3, L4). The digital micromirror device (DMD) and its corresponding controller board (Digital Light Innovations DLP V4390) were used to generate the structured illumination patterns. The DMD is rotated 45° in order to make the input and output beams lie in a common horizontal plane. A detailed description of the optical setup of the DMD is discussed below.

FIG. 10C depicts representative (portions of) patterns for the DMD to generate SIM illumination in accordance with an illustrative embodiment. The patterns are binary stripes oriented at 0°,−60°, and 60° with a 6-pixel period (3 on, 3 off). During one SIM imaging process, the patterns are projected by the DMD (2560×1600 pixels) onto the sample plane in a time series. The second order spatial frequency of the structured illumination patterns at the sample plane is 3.07 μm⁻¹ (i.e., 326 nm period), which is the key to down-modulate the high frequency information and increase imaging resolution. The calculation of the theoretical resolution improvement depends on the choice of the definition of the microscopy resolution. With the emission wavelength λₑₘ=580 nm and a 1.27 NA objective lens being used, the spatial resolution of the wide-field imaging is 228 nm by the Abbe limit (d=lem/2NA), or 278 nm by the Rayleigh criterion (d=λₑₘ/NA). These two definitions of WF resolution are 0.7× or 0.85× of the SIM pattern period. The theoretical resolution improvement of the SIM is correspondingly 1.7× or 1.85×, depending on which definition of WF resolution is used for comparison. The FairSIM reconstruction software adopts the Abbe limit. However, from the FRC analysis of the images of point-like-sources (20 nm fluorescent beads), the resolution improvement obtained is closer to 1.85.

The 3 diffraction beams resulting from the DMD are imaged to the back focal plane of the tube lens (L7) by a pair of relay lenses with 5/4×magnification (L5, L6). A half-wave plate (HWP2) mounted on a piezo rotation stage (Newport AG-PR100) is placed at the focal plane to adjust the polarization of the beams in order to maximize the interference contrast. To introduce spatially-varying aberrations in the illumination path, an optical aberration slide (OAS) is placed at the back focal plane of L7. The OAS was made by manually spreading transparent nail polish (Electron Microscopy Science) on a pre-cleaned slide. FIG. 10D depicts an optical aberration slide in the illumination beam path at the location shown in the schematic of FIG. 10A in accordance with an illustrative embodiment. As shown, the slide is placed at the back focal plane of the tube lens L7, and imaged to the image (sample) plane by the tube lens and objective to introduce spatially-varying aberrations. After propagating through the OAS, the now aberrated 3 coherent diffraction beams are directed to the backport of a Nikon Ti Eclipse microscope body, focused by L7 to the pupil plane (back aperture) of the objective (SR Plan Apo, 60×, 1.27 WI, Nikon), and this forms an interference pattern at the sample plane. For simplicity of demonstration, the OAS only affects illumination light and the emission light is unaffected, so the SLM and conjugate AO only need to operate in the illumination path to compensate. However, this setup with the OAS already manifests significant disruption of the SIM pattern allowing one to demonstrate the capability of the TACO system. The scheme can be extended to the case when the aberration medium affects both illumination and excitation light by placing a wavefront corrector in (a common image plane shared by) both illumination and emission paths. In alternative embodiments, a different configuration and/or different system components may be used.

A high-speed sCMOS array detector (Photometrics Kinetix, 6.5 μm pixel size) is used to record images. A pair of lenses (L9, L10) with a magnification of 2×relay the emission from the output port of the microscope to the detector, hence each pixel in the image corresponds to 54 nm at the sample plane. The reason to have the 2×relay lens pair is to magnify the FOV of the 16 mm 197 c-mount output port to fully cover the large 29.4 mm detector sensor. A deformable mirror (Thorlabs DMH40-P01) was placed at the pupil plane for aberration correction in the detection path. There are several reasons for using a DM instead of an SLM in the detection path. First, fluorescent light is unpolarized, while the SLM only works for light with a certain linear polarization. Second, the phase modulation of the SLM (on light) is wavelength-dependent, so a fluorescent sample, which has a broad emission spectrum, will result in chromatic aberration if using an SLM. Third, although a DM has less detailed phase modulation capacity compared to an SLM, it is sufficient for global aberration correction at the pupil plane. Finally, the update rate of the DM (4 kHz) is much higher than any SLM (e.g., 60 Hz), allowing additional functions such as high-speed focal plane scanning along the z-axis by changing the curvature of the DM.

In an illustrative embodiment, implementation of the TACO method can be conducted in 2 operations. The first operation is an image-based pupil AO iteration using the DM to correct global aberrations manifest in the detection path. During this process, the DMD is set to present a completely uniform image (i.e., uniform illumination) to enable wide-field imaging without any structured illumination. The deformation (shape) of the DM is defined by a linear combination of the first 15 Zernike polynomials. The iteration is based on the SPGD algorithm (Supplementary Document) and the metric is the contrast of the image. Here the contrast is defined as the standard deviation

$$( \sqrt{\frac{1}{N} {\sum }_{i}^{N} {( {I}_{i} - \overline{I} )}^{2}} , , N :$$

total number of pixels, Iᵢ: value of the iₜₕ pixel, Ī: mean pixel value.) of the image. In each iteration step, the Zernike coefficients can be updated to reshape the DM.

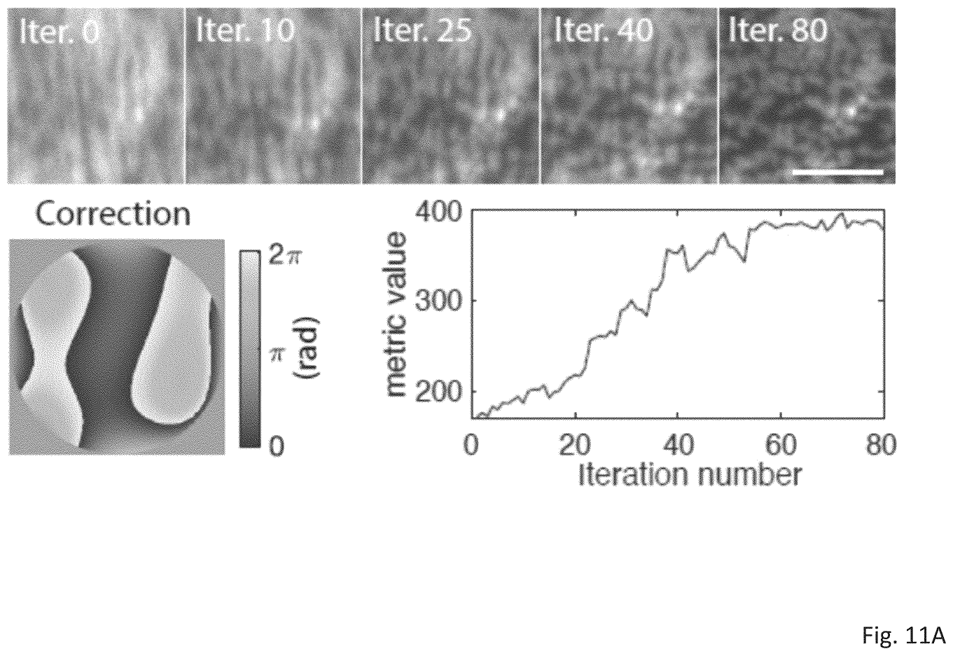

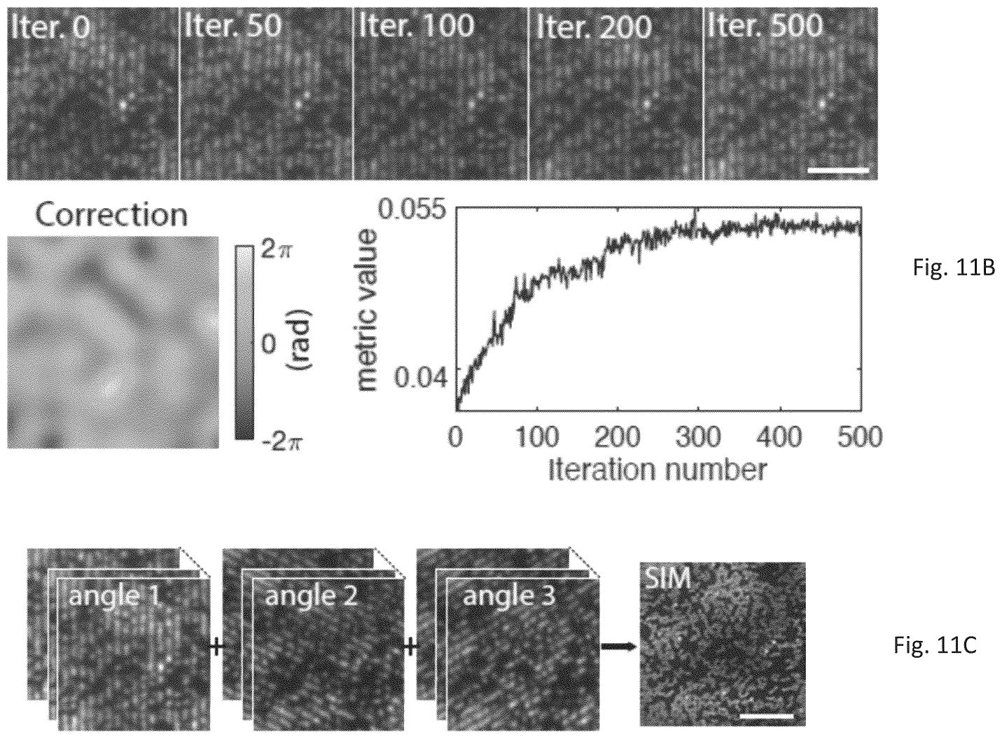

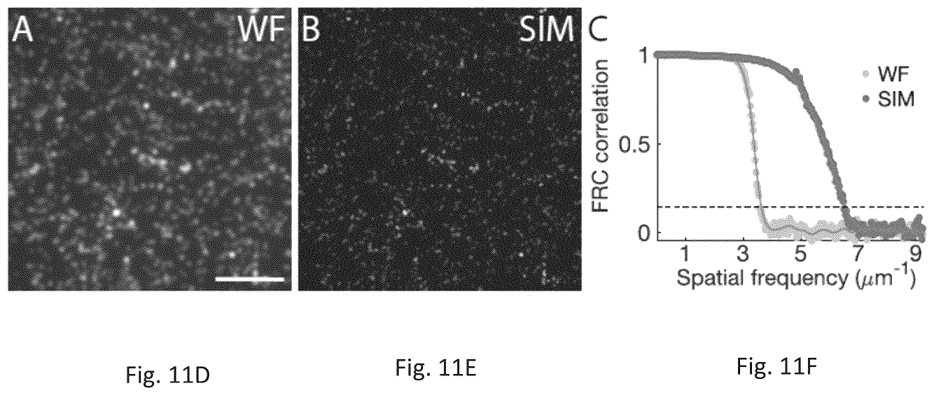

FIG. 11A shows an AO process of the DM on images of fluorescent beads in accordance with an illustrative embodiment. The aberration was introduced by the misalignment of optics. At the beginning of the iteration, the image was severely blurred, while an improvement in image quality can be observed (FIG. 11A, upper) as the DM's shape is adapted to counteract the optical aberration (FIG. 11A, lower left). It typically takes 50˜100 steps for the image contrast to converge to a plateau (FIG. 11A, lower right). Specifically, the upper portion of FIG. 11A shows images of fluorescent beads at different iteration steps, the lower left shows a final wavefront correction pattern of DM, and the lower right shows the metric value of images versus iteration number.

The second operation is an image-based conjugate AO iteration using the SLM to correct spatially varying local aberrations of the illumination path. In this operation, the DMD is tasked with a binary periodic pattern for structured illumination. The wavefront modulation of the SLM is defined by values of a 600×600-pixel array. The metric M is defined in Equation 14 and the iteration procedure is based on the SPGD algorithm, which is described below. Before each update, a Gaussian filter with an empirically determined standard deviation (usually ranging from 0.75 to 1.25) is applied to the SLM pixel array in order to match with the smoothly varying phase topography of the aberration slide.

Theoretically, the phase correction can be achieved by optimizing pixel-by-pixel independently, but this involves many iterations. The use of an appropriate and modest Gaussian kernel substantially reduces the iterations required. For phase modulations out of the 0-2π range, the pixel values can be wrapped at 2π (pixel value=224 in our case) to fit in the modulation range of the SLM. The illumination beam propagates through the aberration slide and becomes strongly distorted. FIG. 11B shows a typical AO process of the SLM on the fluorescent beads images in accordance with an illustrative embodiment. It can be seen that although the AO correction by the DM enables functional wide-field imaging with uniform illumination, the structured illumination pattern shows severe distortion resulting from the aberration slide. This distortion was largely rectified (FIG. 11B, upper) as the SLM updated its pixel array values to compensate the aberration (FIG. 11B, lower left). Typically it takes 300˜ 1000 iterations for the metric to converge (FIG. 11B, lower right). Specifically, the upper portion of FIG. 11B shows images of fluorescent beads superimposed with a SIM pattern at iteration steps, the lower left shows a final wavefront correction pattern of SLM (the phase modulation has been unwrapped to better visualize the phase topography), and the lower right shows the value of the metric of images versus iteration number.

A series of striped illumination patterns formed by the DMD (FIG. 10C) were used to generate structured illumination. The three-beam interference configuration is employed for its optical sectioning capability when imaging 3D samples like cells. The pattern period is 6 pixels and results in an ˜85% improvement in resolution when a good pattern contrast is maintained. The 1.85 [symbol] resolution improvement can be determined by both theoretical calculation and Fourier ring correlation (FRC) analysis on the experimental images of 20 nm fluorescent bead samples (FIGS. 11D-11F discussed below). FIG. 11C shows a set of typical SIM raw images and the associated reconstruction result in accordance with an illustrative embodiment. It is noted that scale bars in FIGS. 11A-11C are 4 μm.

As noted, FIGS. 11D-11F depict a Fourier Ring Correlation (FRC) measurement of 20 nm diameter fluorescent beads samples in accordance with an illustrative embodiment. FIG. 11D is a wide field image of the 20 nm bead samples in accordance with an illustrative embodiment. FIG. 11E is a SIM reconstruction image of the 20 nm bead samples in accordance with an illustrative embodiment. FIG. 11F depicts FRC curves of the WF image and the SIM image in accordance with an illustrative embodiment. The FRC analysis is conducted such that 10 different fields of view (FOVs) were analyzed. For each FOV, two sets of images with the same parameter settings were acquired independently for FRC curve calculation. The image resolutions were determined when the FRC curves drop below a fixed threshold of 1/7. This leads to a wide-field resolution of 282.4±3.6 nm, and a SIM resolution of 153.2±1.8 nm, corresponding to a resolution improvement of 1.84±0.03.

Eighteen patterns with 3 angles×6 phase shifts were used to create the complete image set involved in reconstructing a SIM image. The reason for using 6 phases instead of the conventional 5 phases is to achieve an equidistant phase for the 6-pixel period of the phase patterns. FairSIM, an imageJ-based open-source SIM reconstruction software can be used to reconstruct the 18 raw images of 150×150 pixels into super-resolution SIM of 300×300 pixels, with each pixel corresponding to 27 nm effective pixel size in the image. It is noted that FairSIM uses the OTF attenuation method to retain the optical sectioning ability, which is not a full 3D reconstruction method. More details of the SIM reconstruction are discussed below.

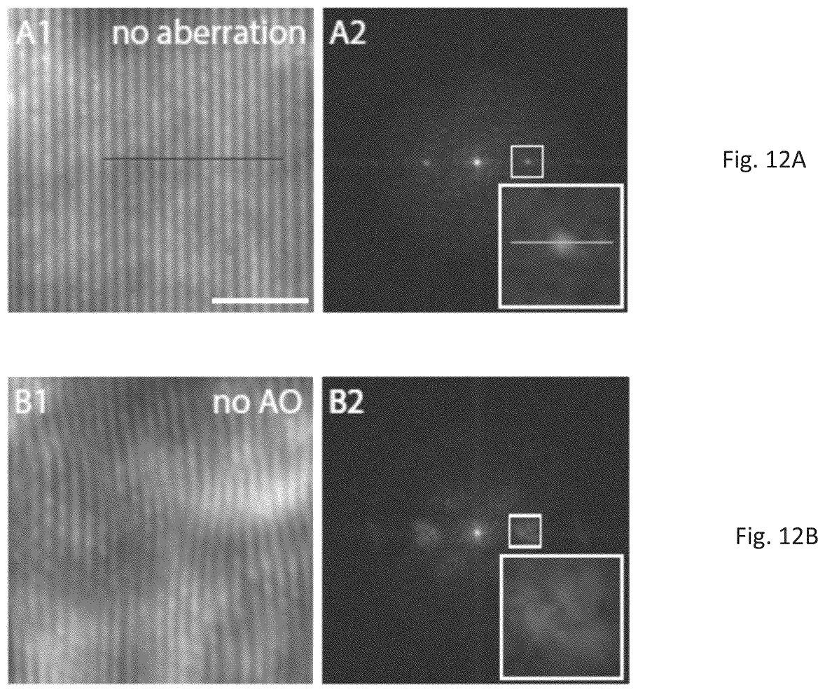

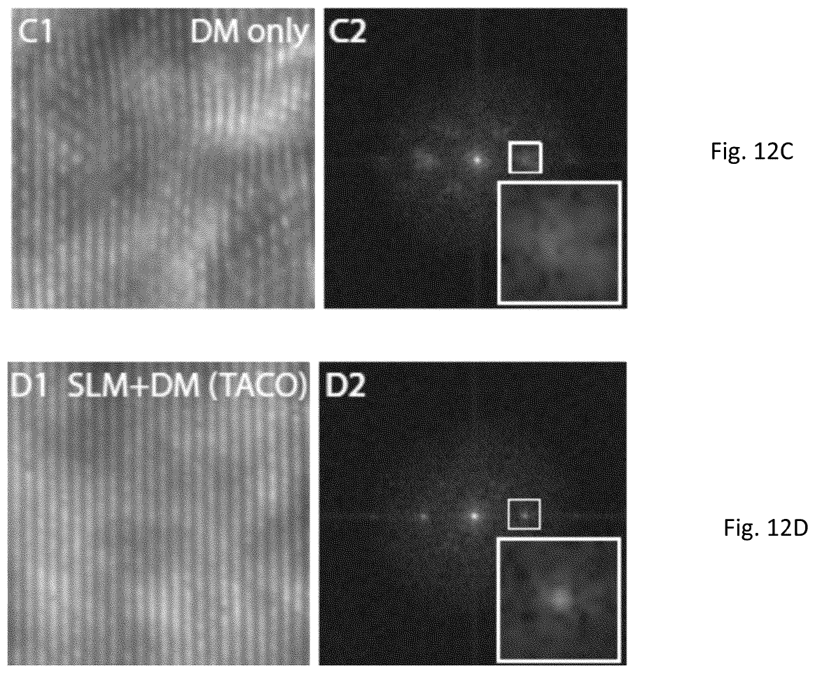

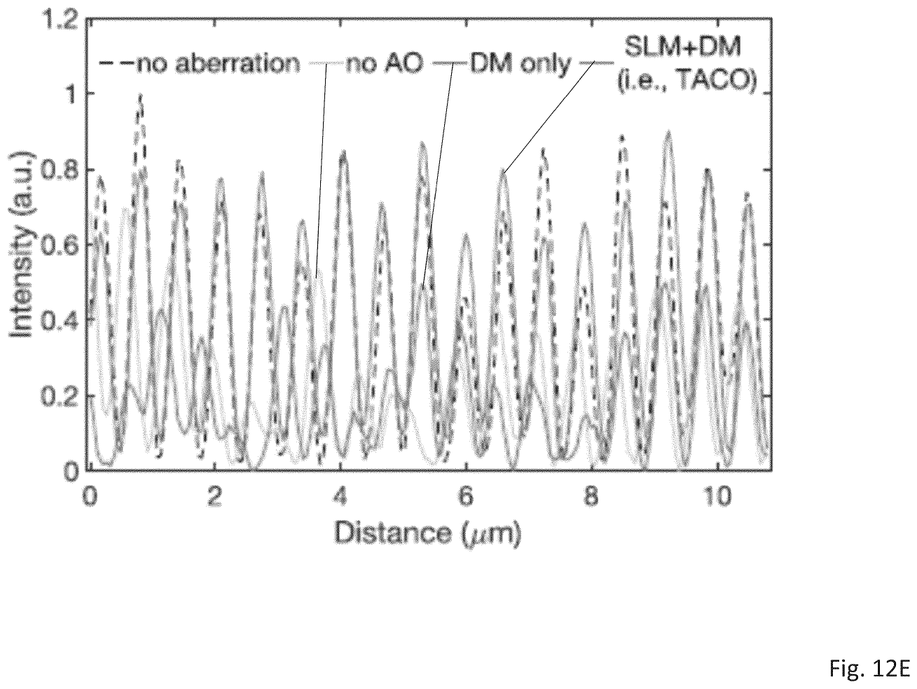

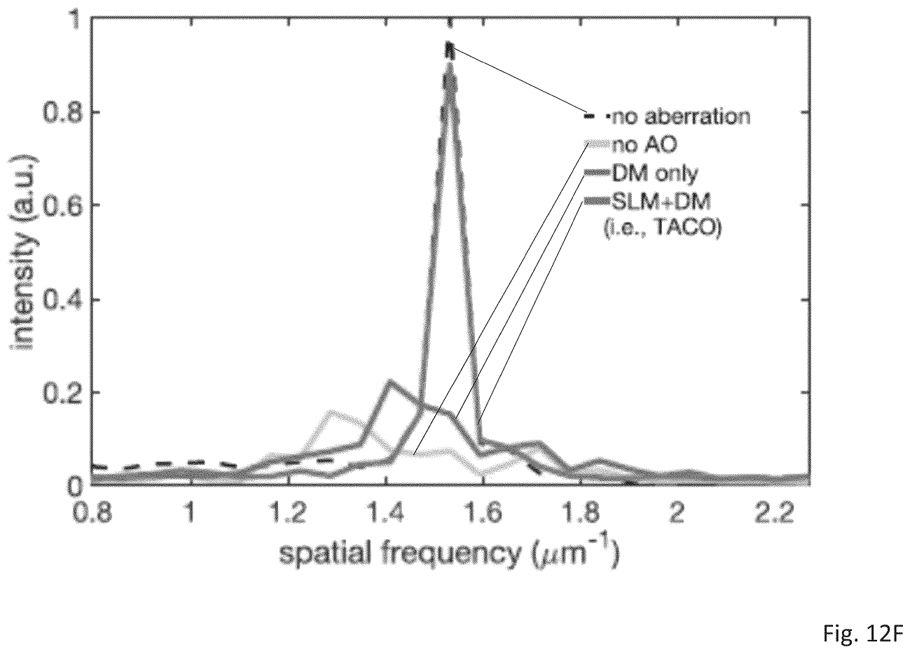

The TACO system was first tested on a nearly uniform thin sample layer of carboxylate-modified polystyrene fluorescent beads. FIG. 12 depicts various experimental structured light patterned samples and their Fourier transforms, including SIM patterns and associated FT for different conditions. FIG. 12A depicts samples (A1 & A2) in which no aberration was introduced in accordance with an illustrative embodiment. FIG. 12B depicts samples (B1 & B2) in which aberration was introduced both globally and locally in accordance with an illustrative embodiment. FIG. 12C depicts samples (C1 & C2) in which only pupil AO correction by the DM was performed in accordance with an illustrative embodiment. FIG. 12D depicts samples (D1&D2) in which both conjugate AO by the SLM and pupil AO by the DM were performed, which is the full implementation of TACO in accordance with an illustrative embodiment. FIG. 12E depicts an intensity profile of a cross-section (line in A1) of the illumination pattern for different conditions in accordance with an illustrative embodiment. Each curve is smoothed by a moving average with a 3-pixel window and subtracted by the image background to reach the same baseline. FIG. 12F depicts an intensity profile of a cross-section (line in A2) around the first-order spot of FTs for different conditions in accordance with an illustrative embodiment. To mitigate the edge artifacts, a Gaussian window with a width factor of 0.6% of the image size were applied to the images before doing the Fourier transform. All the FTs have been scaled by a factor of 2, and Gamma corrections are applied with γ=0.2. The scale bar in FIG. 12A is 5 μm and the effective pixel size is 54 nm. FIG. 12G depicts a large field of view image of the 200 nm diameter bead layer sample with structured illumination from the DMD in accordance with an illustrative embodiment. The scale bar in FIG. 12G is 20 μm.

Comparison of FIGS. 12A and 12B shows that the sinusoidal pattern was severely distorted by the aberration of the optical beam (FIG. 12B1). This is also manifest in the Fourier spectrum since the ±1 diffraction orders are barely discernible (FIG. 12B2). As discussed, FIG. 12C shows the result of only using the DM and pupil AO correction in the detection path. This DM correction resulted in better overall sharpness and contrast in the sinusoidal modulated pattern and its FT (FIG. 12F). However, the spatially varying distortion of the pattern still persists. It is noted that a spotted grid-like pattern is evident. This results from the SLM pixelation, and also causes the minor diffraction orders in the FTs of the patterns. These grid-like patterns are more obvious when there are spatially varying aberrations present. To address the spatially-varying aberration, a tandem stage of conjugate AO correction was conducted using the SLM. After 500 iterations, the pattern was restored nearly to the ideal unaberrated quality (FIG. 12D). After SLM correction, the profile of the pattern has a shape and contrast close to the ideal undistorted case, which is a significant improvement in comparison with the case of DM-only correction (FIG. 12E). The corresponding FTs also show that the diffraction orders following the implementation of TACO become much sharper compared with DM-only correction.

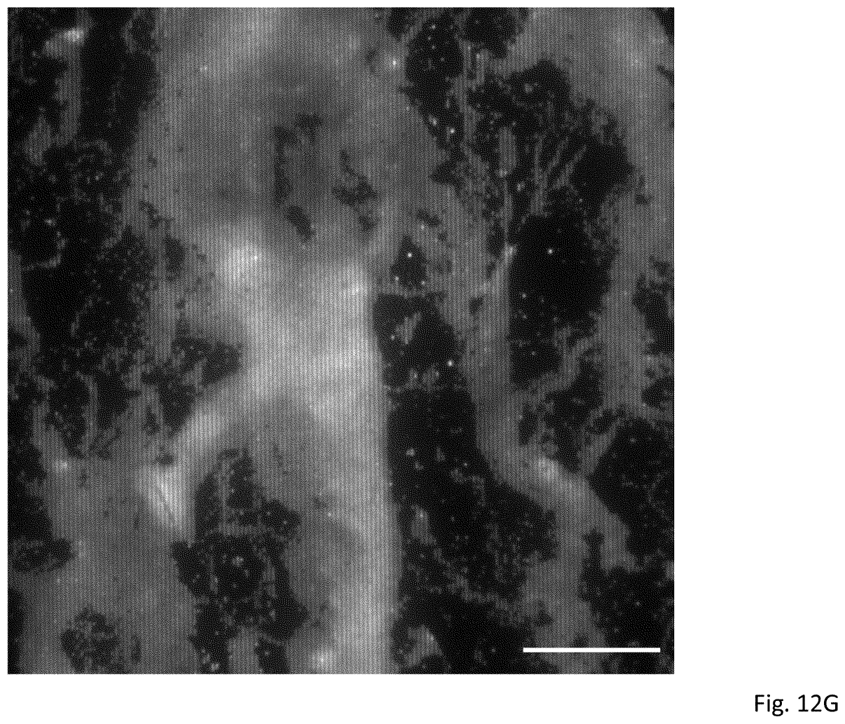

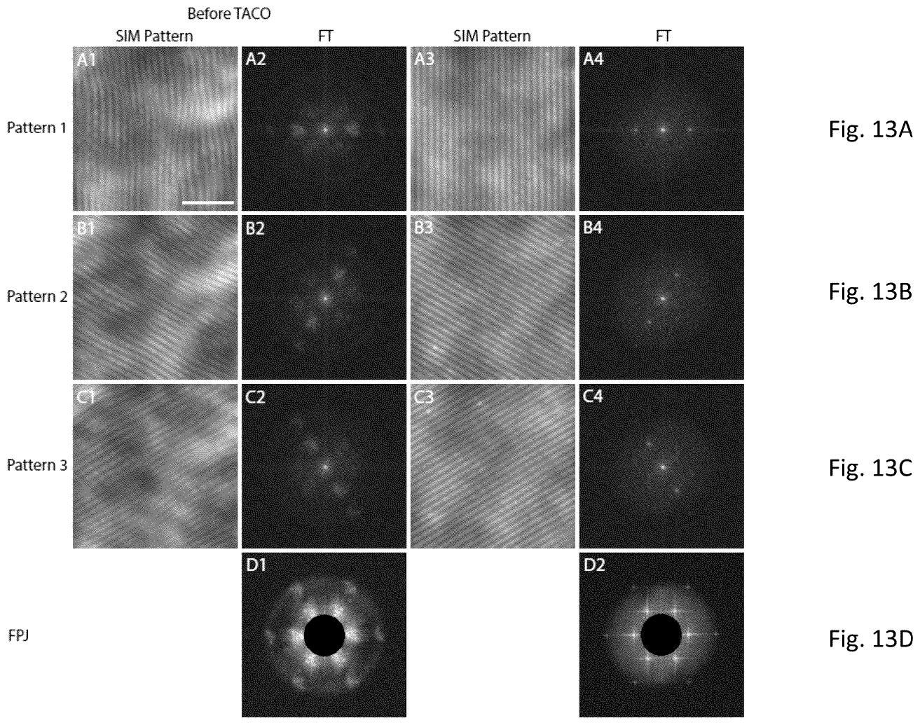

The inventors also tested the same SLM correction on patterns with different orientations as required for SIM reconstruction, and found that the quality of all the sinusoidal patterns (i.e., all 3 orientations) were significantly improved. An iterative SLM-based aberration correction process was conducted based on pattern 1 (FIG. 10C). The resulting SLM phase mask counteracted the aberration introduced from the optical aberration slide and led to a significant improvement in pattern quality in the image plane as well as the sharpness of the diffraction orders in the FT spatial frequency images (A1-A4). FIG. 13A (A1-A4) are images that result from an SLM-based aberration correction process based on pattern 1 in accordance with an illustrative embodiment. FIG. 13B (B1-B4) are images that result from an SLM-based aberration correction process based on pattern 2 in accordance with an illustrative embodiment. FIG. 13C (C1-C4) are images that result from an SLM-based aberration correction process based on pattern 3 in accordance with an illustrative embodiment. FIG. 13D (D1-D2) depict raw Fourier projection (FPJ) of the FTs of the entire 3-6 image set before and after TACO correction in accordance with an illustrative embodiment. With the low-frequency parts being masked, FPJs provide better visualization of the higher diffraction orders. In the FPJ after TACO correction, both first-order and second-order spots show greatly narrowed distributions. This result illustrates that the aberration correction from the SLM is not biased to any single structured illumination pattern. Instead it corrects the whole wavefront back towards an ideal plane wave. In other words, the wavefront is restored to a plane wave, so a single optimization of a single SIM pattern gives an overall correction to all the sinusoidal patterns. The scale bar in A1 of FIG. 13A is 5 μm.

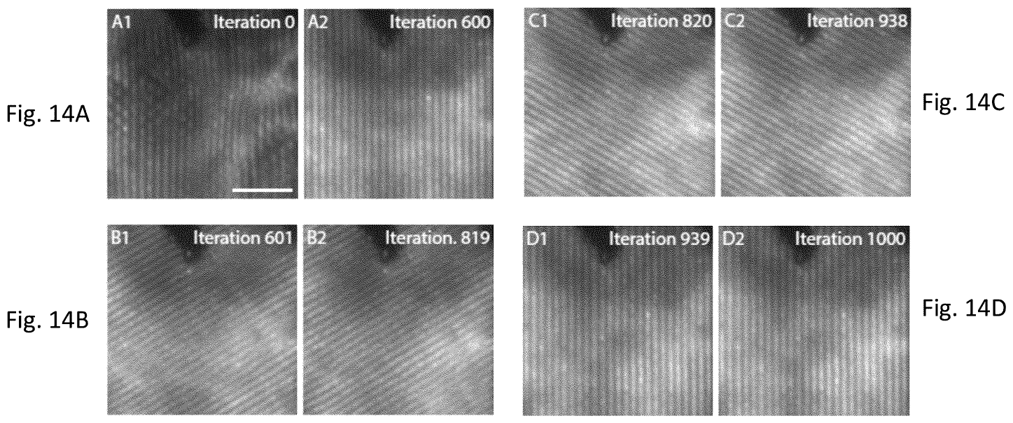

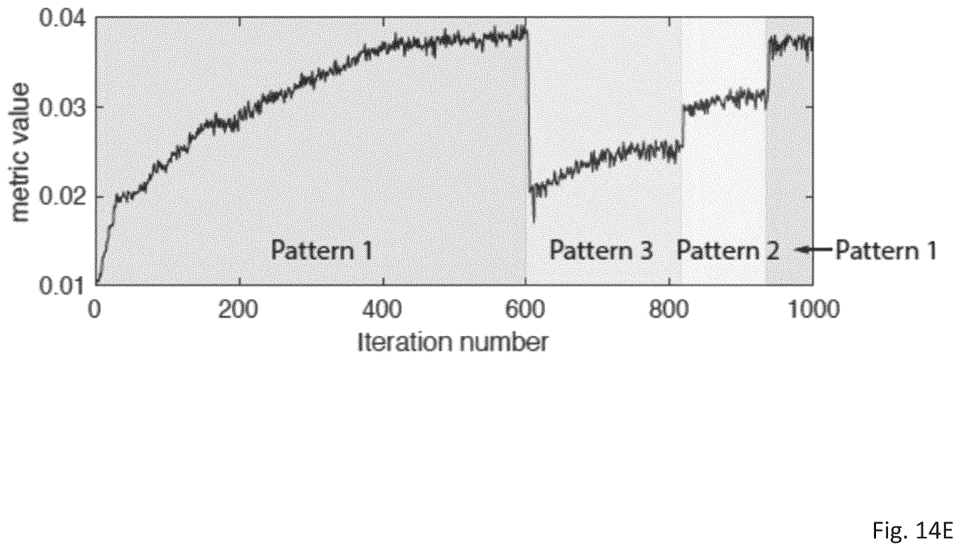

Doing the SLM correction process based on the image quality of multiple angled patterns can also lead to even more thorough improvement at the cost of 50-100 additional iterations. FIG. 14 illustrates an iterative SLM-based aberration correction process using multiple structured illumination patterns. The iteration process is divided into 4 stages. FIG. 14A depicts a first stage of the iterative SLM-based aberration correction process based on pattern 1 (A1, A2) in accordance with an illustrative embodiment. During this stage, the image quality metric defined in equation 2 plateaus to a (relative) maximal value by 600 iterations. FIG. 14B depicts a second stage of the iterative SLM-based aberration correction process based on pattern 3 (B1, B2) in accordance with an illustrative embodiment. FIG. 14C depicts a third stage of the iterative SLM-based aberration correction process based on pattern 2 (C1, C2) in accordance with an illustrative embodiment. FIG. 14D depicts a fourth stage of the iterative SLM-based aberration correction process based on pattern 1 in accordance with an illustrative embodiment. In this fourth stage, the pattern is switched back to pattern 1 and the iteration continues around a hundred rounds to determine if the associated metric value is also converged (D1, D2). Despite stage 1 resulting in an overall correction to all three patterns, stages 2 & 3 still complement the optimization in stage 1 (pattern 1) and slightly further increase the image metric values. The scale bar in A1 of FIG. 14A is 5 μm.

FIG. 14E depicts image metric values associated with the iterative SLM-based aberration correction process using multiple structured illumination patterns in accordance with an illustrative embodiment. The image metric values shown in FIG. 14E manifest jumps and offsets when the pattern is switched because of the difference in intensity distribution and contrast between different patterns. The iteration process is divided into 4 stages. Stage 1 is based on pattern 1 (A1, A2). During this stage, the image quality metric defined in equation 2 plateaus to a (relative) maximal value by 600 iterations (E). Stage 2 is based on pattern 3 (B1, B2). Stage 3 is based on pattern 2 (C1, C2). In stage 4, the pattern is switched back to pattern 1 and the iteration continues around a hundred rounds to determine if the associated metric value is also converged (D1, D2). Despite stage 1 resulting in an overall correction to all three patterns, stages 2 & 3 do complement the optimization in stage 1 (pattern 1) and slightly further increase the image metric values (E). The image metric values shown in (E) manifest jumps and offsets when the pattern is switched because of the difference in intensity distribution and contrast between different patterns. The further improvement of the metric value upon changing the pattern reflects an inherently positive nature of the optimization methodology. When the pattern angle is altered, new information about the wavefront is introduced, enabling further correction of aberrations. The plateau observed in the pattern 1 phase signifies a substantial correction of aberrations based on the information available from that particular pattern. However, as each pattern provides unique insights into the wavefront, switching to patterns 2 and 3 introduces additional, complementary information that enhances the correction process. Ideally, additional iterations between these patterns would lead to an increasingly optimal wavefront correction. In practice, however, the process is limited by factors such as photobleaching, so the total iteration steps was limited to a maximum of 1000. As shown in the figure, this approach still yields a high-quality correction for SIM patterns.

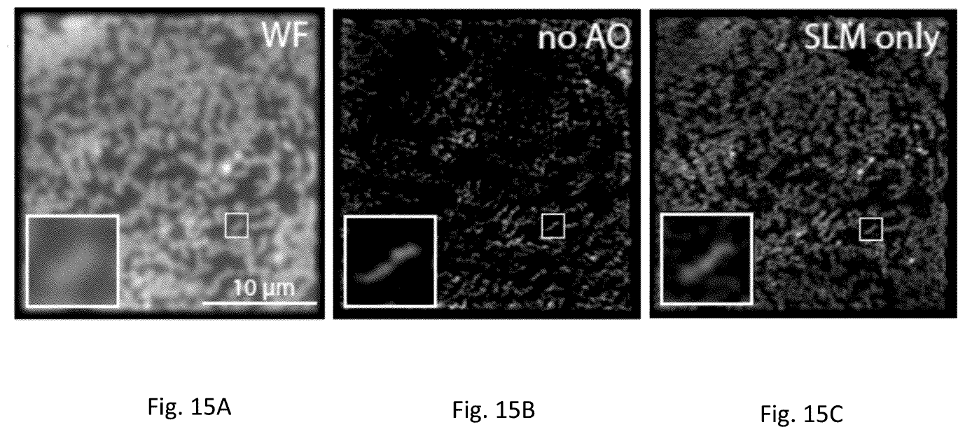

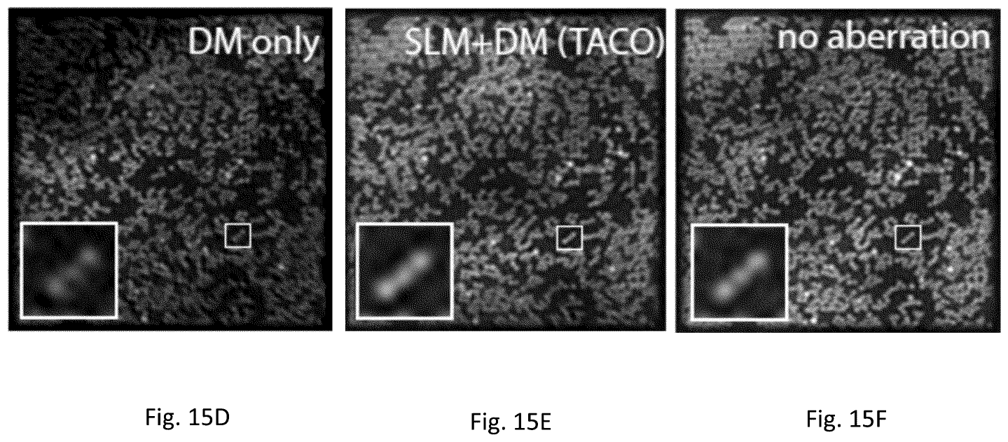

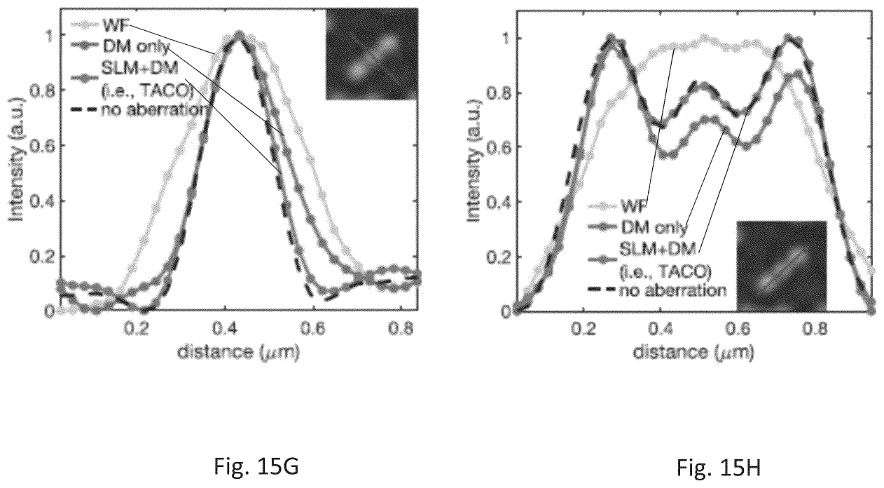

The inventors tested the quality of SIM reconstruction using images of a sparsely distributed 2D 200 nm dia. fluorescent bead sample. FIG. 15 shows experimental SIM imaging of the 200 nm diameter fluorescent bead samples. FIG. 15A is a wide-field image of the fluorescent bead sample in accordance with an illustrative embodiment. FIGS. 15B-15F show SIM reconstructed images of the fluorescent bead sample for different aberration correction conditions. FIG. 15B shows SIM reconstruction after no AO correction was performed in accordance with an illustrative embodiment. FIG. 15C depicts SIM reconstruction after only SLM correction was employed in accordance with an illustrative embodiment. FIG. 15D depicts SIM reconstruction after only DM correction was employed in accordance with an illustrative embodiment. FIG. 15E depicts SIM reconstruction after both SLM and DM correction (i.e., TACO) were employed in accordance with an illustrative embodiment. FIG. 15F shows SIM reconstruction after no aberration was introduced in accordance with an illustrative embodiment.

FIG. 15G shows normalized intensity profiles along the diagonal cut through bead 2 as shown by the line in the inset in accordance with an illustrative embodiment. The profiles of all 3 beads are shown in FIG. 15. FWHM values of beads 1-3 are: WF, 343 nm, 331 nm, 327 nm; DM only, 234 nm, 221 nm, 224 nm; SLM+DM, 207 nm, 191 nm, 183 nm; no aberration, 190 nm, 182 nm, 188 nm. FIG. 15H depicts normalized intensity profiles along the diagonal cut through the 3 beads shown by the line in the inset in accordance with an illustrative embodiment. The measured distances between the three peaks are: left, 216 nm; right, 243 nm. FIG. 15I depicts a power spectrum of images for different conditions in accordance with an illustrative embodiment. Each curve is normalized by its intensity at zero frequency. It is noted that the scale bar in FIG. 15A is 10 μm and the effective pixel size is 27 nm.

Referring again to FIG. 15B, the SIM pattern was corrupted by both spatially-varying aberration and global aberration, while no AO correction was performed. The resulting image reconstruction is poor, showing very pronounced artifacts. In FIG. 15C, only SLM aberration correction for the excitation path was performed, showing some improvement. However, due to the existence of global aberration, the profile of individual beads is still distorted. In FIG. 15D, only detection path aberration correction was performed using the DM. The quality of reconstruction is thus spatially-dependent: in some areas, the reconstructed image is free of artifacts and shows good quality (e,g, at the center of the image), while in other areas (e.g., the upper left and lower right parts), the image quality is still severely deteriorated. This result shows how spatial-dependent aberration corrupts image reconstruction in a different way than global aberrations. Finally, FIG. 15E shows a substantial improvement with full aberration correction, i.e. implementation of TACO. In FIG. 15F, no aberration was introduced, and the image was the most ideal. One can see that the image quality after full TACO correction is very close to the ideal un-aberrated condition of FIG. 15F.

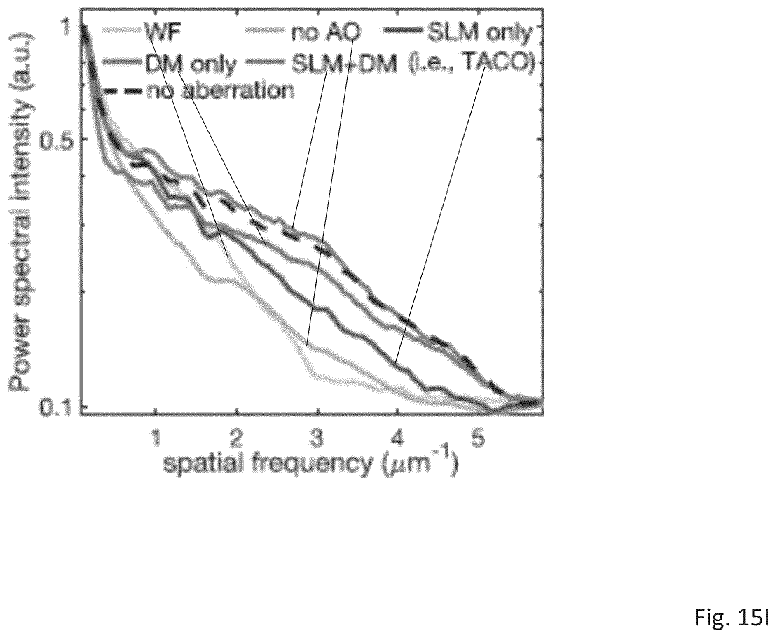

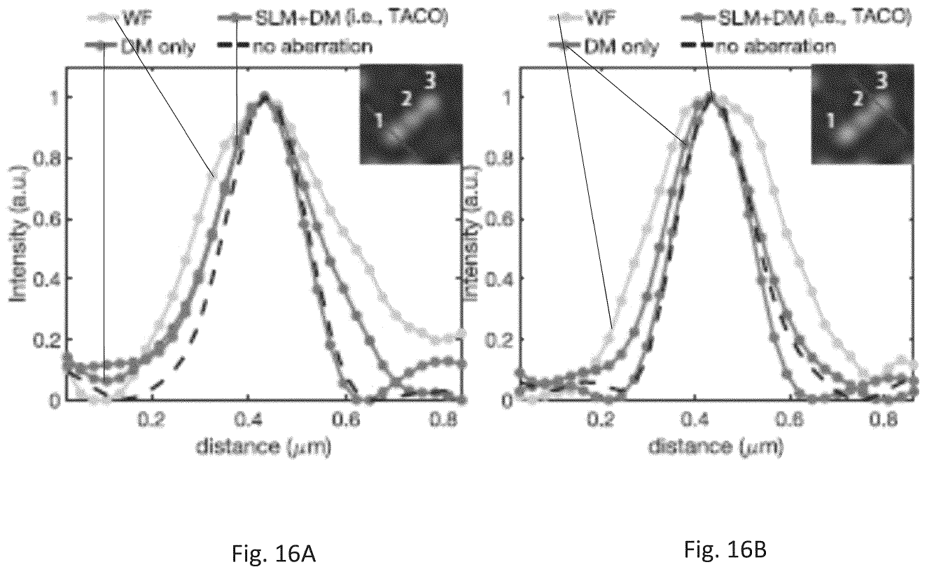

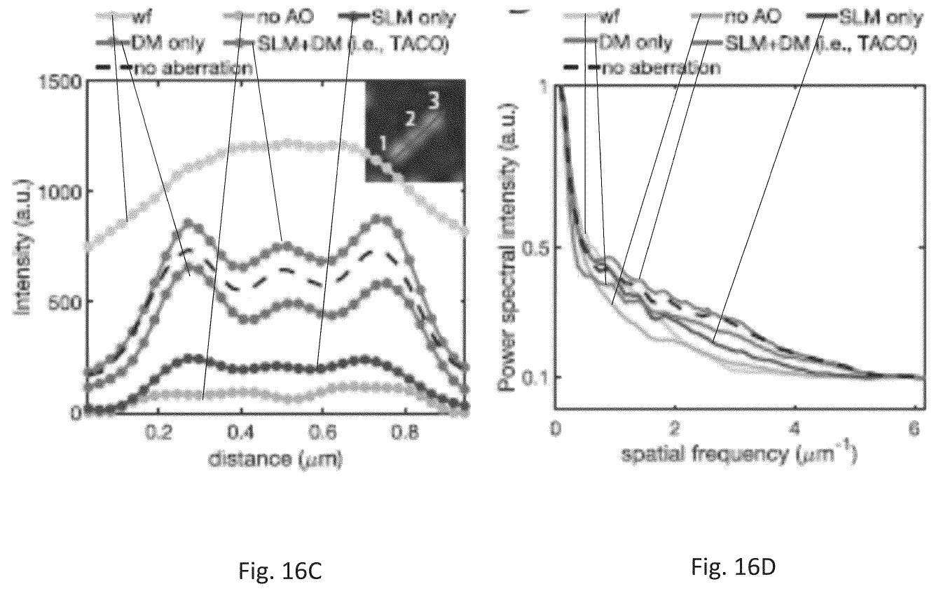

FIG. 15G shows the intensity profile of bead 2 as shown in the inset. The profile shows a clear difference between the different reconstruction strategies. Although DM correction only shows a much sharper profile (FWHM=221 nm) compared to WF (FWHM=331 nm), it is still significantly worse than the no aberration case (FWHM=182 nm). This can also be seen by the distorted shape of the bead image. Conversely, TACO correction leads to a further improved bead profile (FWHM=191 nm) that is very close to the ideal case. Similar results can be seen from the measurements of beads 1 and 3 (FIGS. 16A and 16B). The reason that the FWHM is less than 200 nm may be due to the variance of the manufacturing process.

FIG. 15H further shows the profiles of the three adjacent beads in the insets. Although the DM only correction is good enough to show distinguishable profiles of the 3 beads, the profiles of TACO correction manifest greater fidelity, similar to the unaberrated ideal case. The power spectra of the images for different imaging and correction conditions are obtained from their FTs and shown in FIG. 15I. The y-axis was set to have a log scale to better illustrate the differences between each curve. A linear scale version of the power spectrum analysis is shown in FIG. 16D. Compared with the wide-field condition, all the other images show an expansion of the distribution to higher spatial frequency. However, in the case of no AO correction or SLM-only correction, the intensity of high-frequency components is limited. The case of DM-only correction shows improvement in the high-frequency range but is still much inferior compared with the no-aberration case. By contrast, full implementation of TACO (i.e., both DM and SLM) enhances the frequency distribution to almost the same power spectrum as the ideal case. This further illustrates that the overall quality of the SIM reconstruction after implementing TACO is close to optimum.

FIG. 16 depicts intensity profiles of fluorescent beads for different imaging conditions. FIG. 16A depicts a normalized intensity profile of bead 1 along a line as shown in the inset in accordance with an illustrative embodiment. FIG. 16B depicts a normalized intensity profile of bead 2 along a line as shown in the inset in accordance with an illustrative embodiment. FIG. 16C depicts an unnormalized intensity profile of the 3 adjacent beads along a line as shown in the inset in accordance with an illustrative embodiment. The reason that the TACO correction shows an even higher signal level compared with no aberration is because of the non-uniformity of illumination intensity that arises as a byproduct of the SLM phase modulation. Since the SLM phase modulation cannot completely cancel out the aberration, the final illumination wavefront after SLM correction still deviates slightly from an ideal plane wave, and the intensity distribution can be non-uniform due to the existence of residual phase modulation. FIG. 16D depicts a power spectrum of the same analysis as shown in FIG. 15I with linear scale y-axis instead of log scale in accordance with an illustrative embodiment.

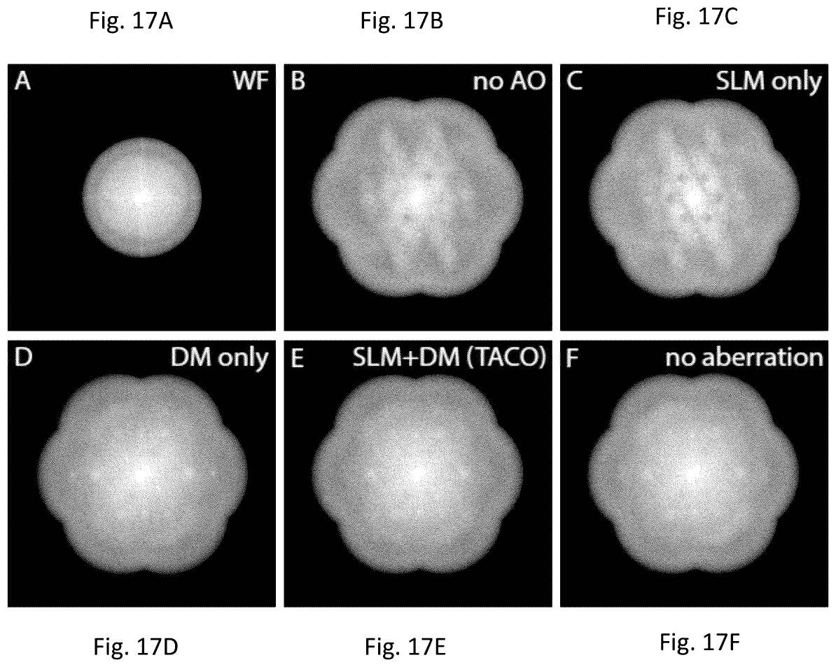

FIG. 17 depicts Fourier transforms of the wide-field (WF) and structured illumination microscopy (SIM) reconstruction images shown in FIG. 15. FIG. 17A depicts a Fourier transform of the WF sample in accordance with an illustrative embodiment. FIG. 17B depicts a Fourier transform of the no AO sample in accordance with an illustrative embodiment. FIG. 17C depicts a Fourier transform of the SLM only sample in accordance with an illustrative embodiment. FIG. 17D depicts a Fourier transform of the DM only sample in accordance with an illustrative embodiment. FIG. 17E depicts a Fourier transform of the SLM and DM (TACO) sample in accordance with an illustrative embodiment. FIG. 17F depicts a Fourier transform of the no aberration sample in accordance with an illustrative embodiment. In the case of no AO (FIG. 17B) and SLM only (FIG. 17C), the FTs show obvious sub-structures that correspond to the strong global artifacts in the (corresponding) SIM reconstructions. These sub-structures are almost completely absent in the FT of the DM-only (FIG. 17D), TACO (FIG. 17E), and no aberration cases (FIG. 17F), because the global aberrations have been largely corrected by the DM. However, strong local aberrations persist in the DM-only case that can be clearly observed in FIG. 15D.

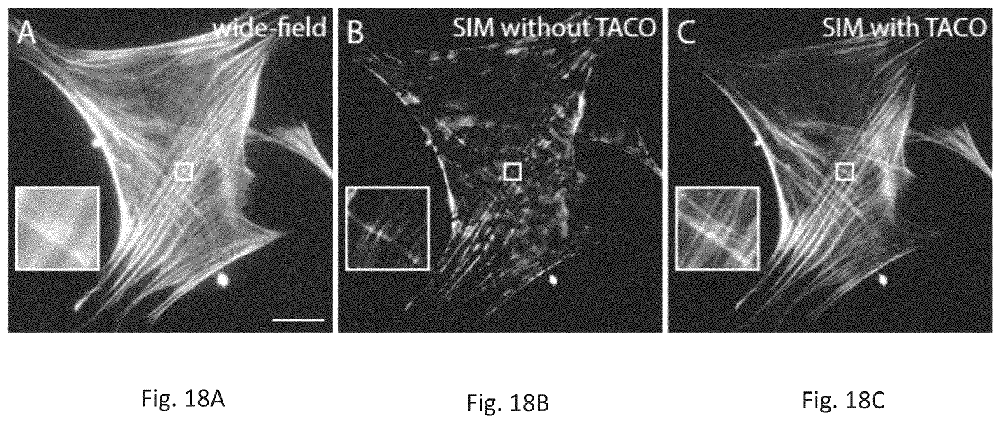

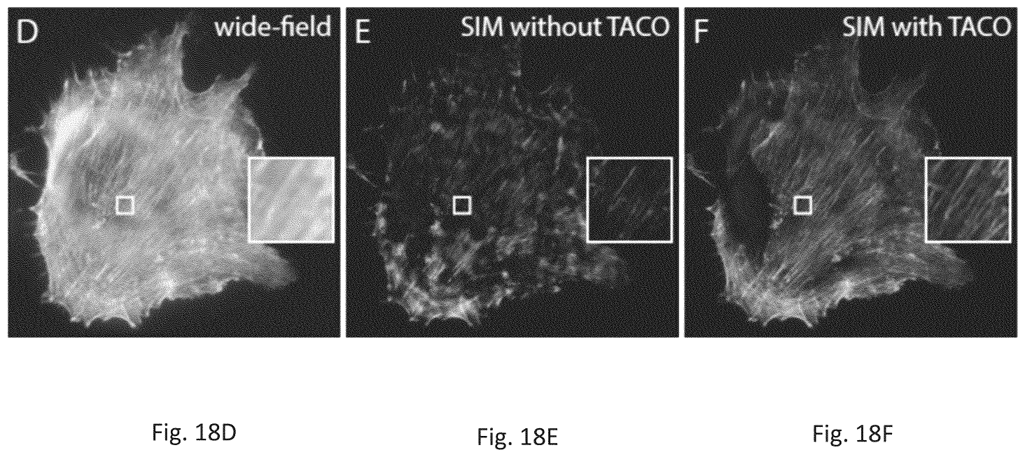

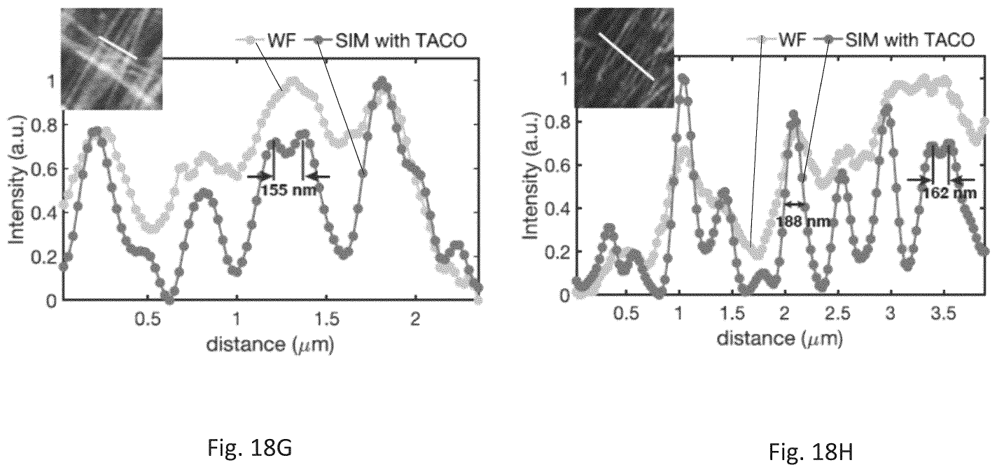

The inventors further tested TACO aberration correction on two different types of cell samples, human fibroblast cells and human melanoma cells. The actin networks of the cells were labeled with Alexa Fluor 555 phalloidin fluorescent dye and SIM imaging was performed with and without the aberration slide. FIG. 18 depicts TACO imaging of phalloidin labeled actin in a human fibroblast cell (upper row) and a human melanoma cell (lower row). FIG. 18A is a first wide field image in accordance with an illustrative embodiment. FIG. 18B depicts SIM reconstruction without TACO in accordance with an illustrative embodiment. FIG. 18C depicts SIM construction with TACO in accordance with an illustrative embodiment. FIG. 18D is a second wide field image in accordance with an illustrative embodiment. FIG. 18E depicts SIM reconstruction without TACO in accordance with another illustrative embodiment. FIG. 18F depicts SIM construction with TACO in accordance with another illustrative embodiment. No additional brightness/contrast adjustment has been added to the images. FIG. 18G depicts normalized intensity profile along the lines as shown in the insets in accordance with an illustrative embodiment. FIG. 18H depicts normalized intensity profile along the lines as shown in the insets in accordance with another illustrative embodiment. It is noted that the scale bar in FIG. 18A is 20 μm and the effective pixel size is 27 nm.

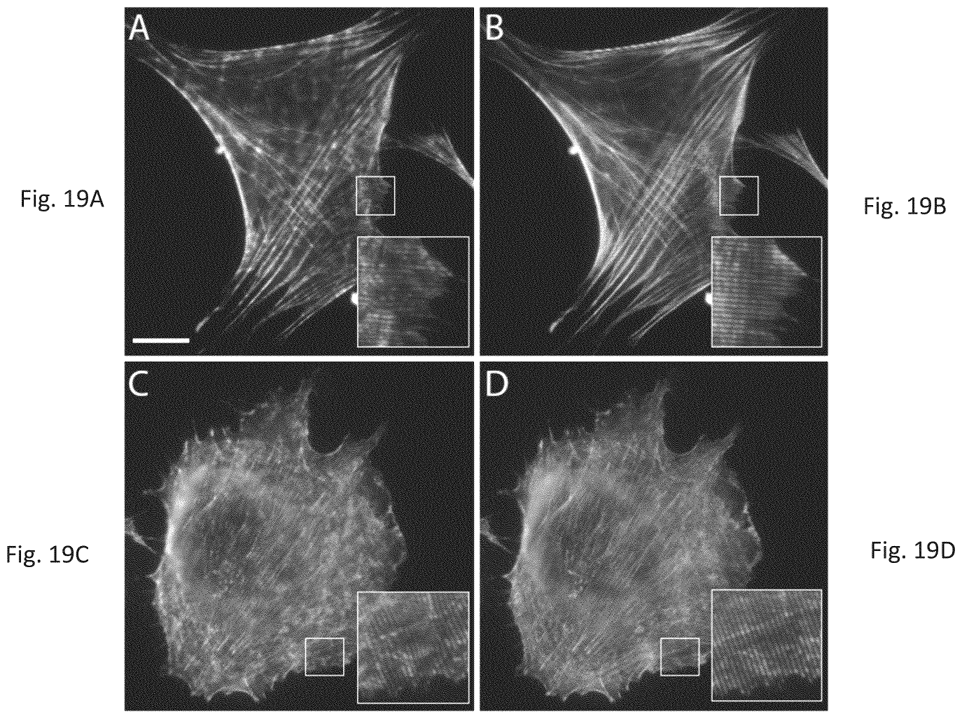

In this experiment, wide-field imaging without any introduced aberration was first conducted as shown in FIGS. 18A and 18D. The images show poorly-resolved actin structures and strong out-of-focus backgrounds. FIGS. 18B and 18E show the reconstruction of SIM imaging, including aberration, but without TACO. Due to the strong perturbation from the aberration slide, the SIM pattern was severely distorted (FIGS. 19A and 19C) and cannot be reconstructed into accurate super-resolution images. That is, one should have low confidence in the cellular features obtained due to the potential artifacts associated with the aberrated illumination patterns. By contrast, the aberration was corrected and the sinusoidal pattern was successfully recovered using TACO (FIGS. 19B and 19D), resulting in high-quality SIM reconstruction. As seen in FIGS. 18C and 18F, SIM reconstructions after TACO shows significantly improved quality, with the artifacts largely eliminated. Compared with wide-field images, the SIM reconstructed super-resolution images show much more detail of the actin networks with improved resolution and contrast, and suppression of the out-of-focus light. As shown in FIGS. 18G and 18H, after SIM reconstruction with TACO correction, the profile of the actin filaments is significantly more defined, and previously indistinguishable actin structures, such as actin branching with separations as small as 155 nm, can be readily resolved.

FIG. 19 depicts images obtained using sinusoidally modulated structured illumination (SIM) patterns before and after TACO. Specifically, FIG. 19A depicts an image of a fibroblast cell prior to use of TACO in accordance with an illustrative embodiment. FIG. 19B depicts an image of the fibroblast cell subsequent to use of TACO in accordance with an illustrative embodiment. FIG. 19C depicts an image of a human melanoma cell prior to use of TACO in accordance with an illustrative embodiment. FIG. 19D depicts an image of the human melanoma cell subsequent to use of TACO in accordance with an illustrative embodiment. Before TACO, the strong aberration from the optical aberration slide severely distorted the illumination pattern in both the human fibroblast cell (FIG. 19A) and the human melanoma cell (FIG. 19C). This distortion led to poor SIM reconstruction with significant artifacts (FIGS. 18B and 18E). After the aberration was corrected by TACO, the illumination pattern was successfully restored (FIGS. 19B and 19D). These high-quality SIM images and their ±60″ oriented complements allow high fidelity SIM super-resolution reconstructions (FIGS. 18C and 18F). The scale bar in FIG. 19A is 20 μm.

In general, research and application of adaptive optics in SIM have almost exclusively focused on the pupil AO configuration. However, unlike point-scanning microscopy, wide-field illumination is quite immune to global aberrations like spherical aberration or coma, but is highly susceptible to spatially-varying aberrations, e.g., caused by sample inhomogeneity or non-flatness of optical components such as DMD. Consequently, the conventional pupil AO aberration correction approach, which is suitable for the correction of global aberrations but not able to correct spatially-varying aberrations, is not sufficient for wide-field based microscopy techniques such as SIM. The proposed tandem aberration correction optics-TACO-method corrects both global and local aberrations in SIM.

The presented version of TACO incorporates a DM for pupil AO in the optical fluorescence detection path to correct for global aberrations, while an SLM is used for conjugate AO in the optical illumination path to compensate for locally-varying aberrations. It has been demonstrated that the TACO system is capable of restoring severe SIM pattern distortion, and that the system enables high-quality super-resolution reconstruction that cannot be recovered by pupil AO alone. It is noted that the main focus of the proposed system is to demonstrate a solution for the long-neglected local aberration lurking in the SIM illumination, instead of the well-studied (both local and global) aberrations in the emission path. Thus the current setup has the conjugate AO only functioning in the illumination path to correct for the spatially-variant aberration caused by the optical aberration slide, while for the emission path a basic pupil AO method is adopted. This optical setup can be expanded to allow imaging of thick aberrating samples by adding a conjugate AO corrector in the detection path to further correct for the spatially-variant aberrations in the detection path. Multi-conjugate AO, or refocusing conjugate AO can also be adopted to accommodate a more realistic aberration sample, such as thick biological tissues.

One limitation of the current setup is that the position of the SLM, near the image plane, leads to the projection of its pixelated image onto the sample plane, causing artifacts in the SIM reconstruction. One solution is to use a wavefront modulator with a more continuous wave shaping function, such as a deformable mirror, or an SLM device with a 100% fill factor (e.g. Meadowlark Optics SLM) that does not show observable pixelation. The present experimental advance (TACO) can also be complemented by computational post-processing. Recently, computational adaptive optics has been shown to compensate aberrations based on purely computational models without the need for wavefront corrector hardware, providing much more flexibility in the choice of the conjugate plane and AO process. This post-processing approach would complement the proposed hardware-based TACO method.

While the effectiveness of the TACO approach has been shown, efforts to accelerate the AO correction speed are also crucial to enhance the imaging process. For instance, more efficient algorithms like the multi-dither coherent optical adaptive technique can be employed, which divides the wavefront corrector into independent segments and determines the phase of each segment in parallel. Devices for direct wavefront sensing have also been designed for large fields of view, such as a partitioned aperture wavefront (PAW) sensor and a spinning-pupil aberration measurement (SPAM) device, which can be used to measure wavefront aberration directly and eliminate the need to do iteration on an image metric.

Overall, the TACO method demonstrates the ability to maintain high-quality SIM illumination and reconstruction when imaging through highly aberrating optical media. Furthermore, the TACO method is not limited to SIM and can also be applied to other wide-field microscopy techniques, such as image scanning microscopy, multi-plane microscopy, and temporal focusing microscopy. Furthermore, TACO can be used to correct non-uniformity of the illumination even for conventional wide-field microscopy. Therefore, this method fills a long-standing gap in applying the AO technique to wide-field-based illumination.

TACO improves wide-field based imaging techniques in biological research, especially for imaging through thick tissues, such as brains or embryos, which can cause strong aberration of the illumination light. The TACO system can greatly mitigate this problem and make possible high-quality wide-field illumination patterns across highly scattering tissues. Compared with conventional point scanning microscopy such as confocal and 2-photon, wide-field imaging techniques have the advantage of being able to image the entire FOV at once without the need to scan over the field of view (FOV) in a time series, and thus could significantly increase the imaging frame rate thereby revealing more details of biological dynamics that were previously inaccessible.

Included below is additional discussion regarding the TACO system, operation of the system, and the experiments conducted to validate its effectiveness. As discussed, the experiments involved both bead samples and cell samples. For the beads, two sizes of fluorescent polystyrene beads, 200 nm and 20 nm diameter were used. For 200 nm beads, two types of slides were prepared using the established precipitation method: (i) a uniform layer of beads and (ii) a slide with sparsely dispersed beads. The bead stock solution (Invitrogen, FluoSpheres carboxylate-modified, 0.2 μm, red) was first sonicated for 10 minutes, then diluted 10× or 100× to prepare bead-layer slides or sparse bead slides, respectively. Four to six μl of each solution was applied on a pre-cleaned coverslip and air-dried overnight. Ten μl of mounting media (Invitrogen) was then applied to the fully dried coverslip. The coverslip was placed and centered on a precleaned microscope slide and sealed with nail polish. The 20 nm beads (Interfacial Dynamics Corp., Fluorescent Red Sulfate Latex) were only prepared as sparsely dispersed slides by the aforementioned method for the precise determination of the SIM resolution as shown in FIGS. 11D-11F.

The human melanoma cells and fibroblast cells were cultured in high-glucose DMEM (Life Technologies 10569) supplemented with fetal bovine serum (10%, Life Technologies 26140) and penicillin-streptomycin (200 U/mL, Life Technologies 15140) under standard atmosphere conditions (5% CO₂, 37° C.). Cell cultures were trypsinized at 30-40% confluence and transferred to glass-bottom dishes (Mattek P35G-1.5-14-C) at 70-80% confluence one day before microscopy measurements. For fluorescence imaging, the cell's F-actin network was labeled by Alexa Fluor 555 Phalloidin (Thermo Fisher Scientific, A34055) following the standard protocol provided by the manufacturer.

Regarding the optical setup for the digital micromirror device, the DMD (Texas instrument, DLP9000X VIS WQXGA) used was composed of an array of 2560×1600 micromirrors that can be switched “on/off” by tilting ±12° along their diagonal. This structure makes the DMD equivalent to a blazed grating, and makes it non-trivial to find an optimal incident angle that matches the excitation wavelength and achieves a high diffraction efficiency. To address this issue, it was determined that for 532 nm excitation, an incident angle of ˜24° can achieve a close-to-blazed condition at the −4 diffraction order, while maintaining the output beam perpendicular to the plane of the DMD. It is noted that this blazed grating structure makes it intrinsically difficult to achieve multi-color illumination. However, other optical devices such as spatial light modulator (SLM) or binary grating can also be used for multi-color SIM pattern generation without the need to worry about the blazed grating condition.

When generating patterns for SIM, binary striped patterns are produced through the DMD, and two more diffraction orders are generated around the −4th diffraction order. These 3 diffraction spots are used as the 0^{th} and ±1 beams for the generation of the SIM pattern at the sample plane through 3-beam interference. All the rest of the diffraction orders are prevented from reaching the sample. The intensity ratio of the ±1 diffraction spots to the 0^{th} order spot is approximately 0.5:1. This allows for generation of SIM patterns with high contrast to achieve high-quality SIM reconstructions. Increasing this intensity ratio can further improve the illumination pattern's contrast, which can potentially be achieved by partially blocking the intensity of the 0th-order beam.

As discussed above, the stochastic parallel gradient descent (SPGD) algorithm was used for the iteration and the step-wise increase of the image quality metric for both the SLM (metric defined in Equation 14) and the deformable mirror (DM) where image contrast is used as a metric. A discussion of this algorithm is included below. One can consider an image quality metric M that is a function of the phase modulation of each controllable segment of a wavefront corrector ¢={ϕ1, ϕ2, . . . ϕ_{N},} so that:

$$M ( ϕ ) = M ( \{ {ϕ}_{1} , {ϕ}_{2} , … {ϕ}_{N} , \} ) \qquad Eq . 15$$

When small perturbations {δφ₁, δφ₂, . . . δϕ_{N},} are applied to the phase modulation device, the change of the metric M can be expressed as the Taylor series expansion:

$$δ M = {\sum }_{i = 1}^{N} \frac{\partial M}{\partial {ϕ}_{i}} δ {ϕ}_{i} + \frac{1}{2} {\sum }_{i = 1}^{N} {\sum }_{j = 1}^{N} \frac{{\partial }^{2} M}{\partial {ϕ}_{i} \partial {ϕ}_{j}} δ {ϕ}_{i} {δϕ}_{j} + … \qquad Eq . 16$$

One can also consider the phase modulation ϕₖ from a specific segment k. Multiplying δϕₖ to both sides of equation 16 gives:

$$δ M {δϕ}_{k} = \frac{\partial M}{\partial {ϕ}_{k}} {( δ {ϕ}_{k} )}^{2} + {n}_{k} \qquad Eq . 17$$

in which nₖ is the following noise term:

$${n}_{k} = {\sum }_{i \neq 1}^{N} \frac{\partial M}{\partial {ϕ}_{i}} δ {ϕ}_{i} , {ϕ}_{k} + \frac{1}{2} {\sum }_{i = 1}^{N} {\sum }_{i = 1}^{N} \frac{{\partial }^{2} M}{\partial {ϕ}_{i} \partial {ϕ}_{j}} δ {ϕ}_{i} {δϕ}_{j} δ {ϕ}_{k} + … \qquad Eq . 18$$

The phase perturbations are chosen to be statistically independent random variables that have zero means [symbol] ϕᵢ [symbol] =0 and equal variances [symbol] ϕᵢϕⱼ [symbol] =σ²δ_{i,j}, in which δ_{i,j}=1 when i=j and δ_{i,j}=0 when i≠j. Then the expectation value of the first and second terms are all zero because [symbol] ϕᵢϕⱼ [symbol] =0 for all i≠k and [symbol] ϕᵢϕⱼϕₖ [symbol] =0 for all i, j, k. In this way, the expectation value of the noise term is of the order of σ⁴, and can be expressed as [symbol] nₖ [symbol] = [symbol] (σ⁴), and the expectation value of equation S3 can be expressed as:

$$〈 δ M {δϕ}_{k} 〉 = \frac{\partial M}{\partial {ϕ}_{k}} {σ}^{2} + 𝒪 ( {σ}^{4} ) , \qquad Eq . 19$$

and an approximation for the gradient

$$\frac{\partial M}{\partial {ϕ}_{k}}$$

is:

$$\frac{\partial M}{\partial {ϕ}_{k}} = \frac{〈 δ M δ {ϕ}_{k} 〉}{{σ}^{2}} - 𝒪 ( {σ}^{2} ) . \qquad Eq . 20$$

One can make the same approximation of the gradients for all the segments, and in this way, obtain approximations of the gradient components of metric M versus all segment values ϕ in parallel with an accuracy of [symbol] (σ²). One can thus develop the iteration of the SPGD procedure as:

$${ϕ}_{i}^{m + 1} = {ϕ}_{i}^{m} - b ( \frac{\partial M}{\partial {ϕ}_{i}} ) = {ϕ}_{i}^{m} - b δ {M}^{m} δ {ϕ}_{i}^{m} , \qquad Eq . 21$$

where m is the iteration step, and b is a constant to control the rate of each iteration. The constant b is positive when the metric needs to be minimized and is negative when the metric needs to be maximized. In the present work, a variation of the standard SPGD algorithm was used by taking two measurements with 2 opposite perturbations in each iteration step to arrive at:

$$δ {M}_{+} = M ( ϕ + δ ϕ ) - M ( ϕ ) , δ {M}_{-} = M ( ϕ - δ ϕ ) - M ( ϕ ) \qquad Eq . 22$$

Therefore, for each iteration step, one can update the phase values by:

$${ϕ}_{i}^{m + 1} = {ϕ}_{i}^{m} - 2 b ( δ {M}_{+}^{m} - δ {M}_{-}^{m} ) δ {M}_{i}^{m} . \qquad Eq . 23$$

In practice, an interactive Labview-based software interface was created to show a time-developing plot of metric value M and the images taken in each iteration in real-time. Therefore, the user can empirically determine when to stop the optimization or switch to a different pattern and continue the optimization, as shown in FIG. 14. The convergence of an optimization was determined by visual inspection of the metric value reaching a plateau. Specifically, for FIG. 14, the different patterns were executed for sufficient amounts of time to determine a plateau behavior for each. Finally, pattern 1 is revisited to verify whether the other pattern optimizations also affected pattern 1.

As also discussed above, SIM reconstruction was performed using FairSIM. FairSIM (v1.4.1) is an ImageJ based open-source software that can be used for the reconstruction of 3-beam interference. Theoretically approximated OTF was used for reconstruction. An OTF attenuation function was used to retain optical sectioning. In contrast with the classic full-3D reconstruction, the application of this OTF attenuation method in 3-beam interference SIM has the advantage of only requiring images from a single z-slice for reconstruction without compromising lateral spatial resolution. This method greatly simplifies the process and increases the robustness of the reconstruction, and has been widely used in SIM imaging for 3D samples. The trade-off in signal-to-noise ratio of this method is acceptable. However, it might not be suitable for imaging in extremely low light conditions. FairSIM has setting values for several parameters in the present case. The Wiener parameter was set to be 0.05 as default. The APO cutoff was set to be 1.7 to match the resolution improvement approximation by FairSIM. APO bend was set to be 0.9 as default, and RL iteration was not used for reconstruction.

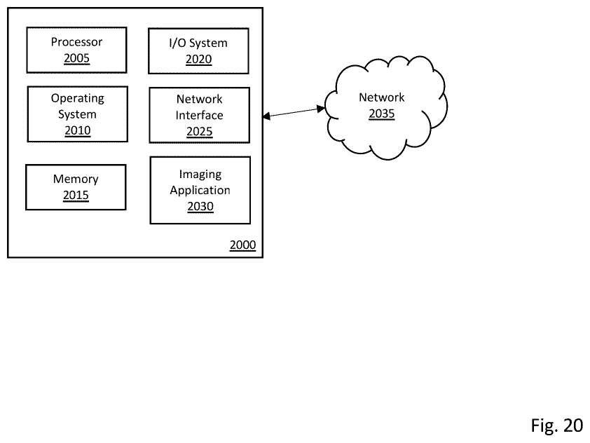

In an illustrative embodiment, any of the operations described herein can be performed by a computing system that includes a processor, a memory, a user interface, a transceiver, etc. The memory can be used to store computer-readable instructions that, upon execution by the processor, cause the computing system to perform the operations described herein. All or a portion of the computing system can be incorporated into an imaging system in one embodiment. For example, the computing system can be incorporated into an imaging sensor. All or a portion of the computing system can also be in the form of a system that is remote from the imaging system and used to process image data received from the image sensor. As an example, FIG. 20 is a block diagram of a computing system 2000 to implement an imaging system in accordance with an illustrative embodiment. The computing system 2000 can communicate directly with other computing devices (e.g., servers, processors, etc.), or through a network 2035, depending on the implementation.

The computing system 2000 includes a processor 2005, an operating system 2010, a memory 2015, an input/output (I/O) system 2020, a network interface 2025, and an imaging application 2030. In alternative embodiments, the computing system 2000 may include fewer, additional, and/or different components. The components of the computing system 2000 communicate with one another via one or more buses or any other interconnect system. In embodiments in which the computing system is remote from the image sensor, the computing system 2000 can be any type of computing device (e.g., tablet, laptop, desktop, smartphone, etc.) that has sufficient processing power to perform the operations described herein.

The processor 2005 can be in electrical communication with and used to control any of the system components described herein. For example, the processor can be used to execute the imaging application 2030, process received user selections and settings, send data and commands to system components, receive raw data from an image sensor, process the data using the algorithms described herein, etc. The processor 2005 can be any type of computer processor known in the art and can include a plurality of processors and/or a plurality of processing cores. The processor 2005 can include a controller, a microcontroller, an audio processor, a graphics processing unit, a hardware accelerator, a digital signal processor, etc. Additionally, the processor 2005 may be implemented as a complex instruction set computer processor, a reduced instruction set computer processor, an x86 instruction set computer processor, etc. The processor 2005 is used to run the operating system 2010, which can be any type of operating system.

The operating system 2010 is stored in the memory 2015, which is also used to store programs, sample data, readings and settings, network and communications data, peripheral component data, the imaging application 2030, and other operating instructions. The memory 2015 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc. In some embodiments, at least a portion of the memory 2015 can be in the cloud to provide cloud storage for the system. Similarly, in one embodiment, any of the computing components described herein (e.g., the processor 2005, etc.) can be implemented in the cloud such that the system can be run and controlled through cloud computing.

The I/O system 2020 is the framework which enables users and peripheral devices to interact with the computing system 2000. The I/O system 2020 can include a display, one or more speakers, one or more microphones, a keyboard, a mouse, one or more buttons or other controls, etc. that allow the user to interact with and control the computing system 2000. The I/O system 2020 also includes circuitry and a bus structure to interface with peripheral computing devices such as power sources, universal service bus (USB) devices, data acquisition cards, peripheral component interconnect express (PCIe) devices, serial advanced technology attachment (SATA) devices, high-definition multimedia interface (HDMI) devices, proprietary connection devices, etc.

The network interface 2025 includes transceiver circuitry (e.g., a transmitter and a receiver) that allows the computing device 2000 to transmit and receive data to/from other devices such as a remote data processing center, an image sensor, servers, websites, etc. The network interface 2025 enables communication through the network 2035, which can be one or more communication networks. The network 2035 can include a cable network, a fiber network, a cellular network, a wi-fi network, a landline telephone network, a microwave network, a satellite network, etc. The network interface 2025 also includes circuitry to allow device-to-device communication such as Bluetooth® communication.

The imaging application 2030 can include software and algorithms in the form of computer-readable instructions which, upon execution by the processor 2005, performs any of the various operations described herein such as controlling an image sensor, processing data received from an image sensor, executing algorithms, generating images, controlling individual system components such as the DMD, implementing the TACO method, sending/receiving data, etc. The imaging application 2030 can utilize the processor 2005 and/or the memory 2015 as discussed above. In an alternative implementation, the imaging application 2030 can be remote or independent from the computing system 2000, but in communication therewith.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A structured illumination microscopy system comprising:
a plurality of light sources, wherein each light source in the plurality of light sources emits an excitation beam, and wherein the excitation beams vary in wavelength;
a plurality of dichroic mirrors positioned to collimate the excitation beams emitted from the plurality of light sources into a multicolor beam;
a blazed grating positioned to receive the multicolor beam and to disperse the multicolor beam into a plurality of monochrome beams, wherein the blazed grating directs the plurality of monochrome beams toward a digital micromirror device;
the digital micromirror device positioned to receive the plurality of monochrome beams from the blazed grating and to direct the plurality of monochrome beams toward a sample; and
an image sensor positioned between the digital micromirror device and the sample, wherein the image sensor generates an image of the sample based at least in part on an interaction of the plurality of monochrome beams and the sample.

2. The system of claim 1, further comprising a pair of lenses positioned to receive the multicolor from the plurality of dichroic mirrors.

3. The system of claim 2, further comprising an aperture positioned between the pair of lenses, wherein the aperture includes a diamond pinhole to clean a profile of the multicolor beam.

4. The system of claim 1, wherein the plurality of light sources comprises lasers.

5. The system of claim 1, wherein the blazed grating includes at least 600 lines per millimeter.

6. The system of claim 1, further comprising a pair of relay lenses positioned between the blazed grating and the digital micromirror device.

7. The system of claim 6, wherein the blazed grating generates a first order diffraction of each of the monochrome beams, wherein the first order diffractions are provided to the digital micromirror device.

8. The system of claim 1, wherein the digital micromirror device generates a pattern and projects the pattern onto a sample plane of the sample.

9. The system of claim 8, wherein the pattern comprises a striped binary pattern.

10. The system of claim 1, wherein the digital micromirror projects a plurality of patterns onto a sample plane of the sample.

11. The system of claim 10, wherein each pattern in the plurality of patterns includes a different angle and phase.

12. The system of claim 1, further comprising a multi-band dichroic mirror and a bandpass filter positioned to separate excitation light from emission light.

13. A method of performing microscopy, the method comprising:
emitting, by each of a plurality of light sources, an excitation beam, wherein the excitation beams vary in wavelength;
collimating, by a plurality of dichroic mirrors, the excitation beams emitted from the plurality of light sources into a multicolor beam;
dispersing, by a blazed grating positioned to receive the multicolor beam, the multicolor beam into a plurality of monochrome beams, wherein the dispersing comprises directing the plurality of monochrome beams toward a digital micromirror device;
receiving, by the digital micromirror device, the plurality of monochrome beams from the blazed grating and directing the plurality of monochrome beams toward a sample; and
generating, by an image sensor positioned between the digital micromirror device and the sample, an image of the sample based at least in part on an interaction of the plurality of monochrome beams and the sample.

14. The method of claim 13, further comprising generating, by the blazed grating, a first order diffraction of each of the monochrome beams, wherein the first order diffractions are provided to the digital micromirror device.

15. The method of claim 13, further comprising generating, by the digital micromirror device, an illumination pattern.

16. The method of claim 15, further comprising projecting, by the digital micromirror device, the illumination pattern onto a sample plane of the sample.

17. The method of claim 15, wherein the illumination pattern comprises a striped binary pattern.

18. The method of claim 13, further comprising generating and projecting, by the digital micromirror device, a plurality of illumination patterns onto a sample plane of the sample.

19. The method of claim 19, wherein each pattern in the plurality of patterns includes a different angle and phase.

20. The method of claim 13, further comprising cleaning, by an aperture having a diamond pinhole that is positioned between a pair of lenses, a profile of the multicolor beam.
